(19) United States
(12) Patent Application Publication
(10) Pub. No.: US 2002/0065788 A1
(43) Pub. Date: May 30, 2002

(54) Mediation negotiating method, negotiation responding method, and computer-readable recording medium and program thereof

(76) Inventors: Masaaki Nishikiori, Kawasaki (JP); Yasuhiko Hashidume, Kawasaki (JP); Takashi Yabe, Kawasaki (JP)

Correspondence Address: STAAS & HALSEY LLP, 700 11TH STREET, NW, SUITE 500, WASHINGTON, DC, 20001, US

(21) Appl. No.: 09/964,563

(22) Filed: Sep. 28, 2001

Related U.S. Application Data
(63) Continuation-in-part of application No. 09/778,485, filed on Feb. 7, 2001.

(30) Foreign Application Priority Data
Sep. 29, 2000 (JP) 2000-297924
Mar. 15, 2001 (JP) 2001-073696

(51) Int. Cl. G06F 17/60; H04L 9/00

(52) U.S. Cl. 705/80

(57) ABSTRACT

A negotiation between a requestor and responders is mediated through a network. A mediation negotiating method has: a request forming step which forms requesting conditions in which priorities have been allocated to request contents in response to a mediating request of the requestor; a requesting step which forms a negotiation field between a plurality of responders selected in accordance with the requesting conditions and the requestor, inputs the requesting conditions, and notifies all of the selected responders of the requesting conditions; and a responding step which receives response information from the responders who participate in the negotiation field and notifies all participants including the requestor and the other responders of the received response information.

### BACKGROUND OF THE INVENTION

1. Field of the Invention

The invention relates to a mediation negotiating method and a negotiation responding method of mediating a negotiation between a requester and responders through a network, to a computer-readable recording medium in which a program for realizing such methods has been stored and to a program thereof. More particularly, the invention relates to a mediation negotiating method and a negotiation responding method of enabling a negotiation to be carried on while requesting conditions and response information inputted to a negotiation field formed on a network are shown to all participants and to a computer-readable recording medium in which a program for realizing such methods has been stored.

2. Description of the Related Arts

Hitherto, as for an auction which is performed via the Internet, Intranet, or the like, a common information referring function and a common information setting function have been provided between a requestor and responders who receive a request, that is, responders, thereby supporting a negotiation between persons. For example, at an auction of YAHOO, it has a category of a layer structure such as computer, business office, or the like. When the category is selected, an auction list having items such as photograph, title, current price, the number of bids, and remaining time is displayed as, for example, “general office equipment”. By selecting a desired item among them, “details of article” is displayed and the user can see article information or the like in it. “information of exhibitor” is shown in “details of article” and by opening it, the user can also see an exhibition situation, “evaluation of exhibitor” by a user's comment, or the like.

However, such a mediation negotiation model such as an auction or the like which is carried out on the assumption that a direct negotiation between persons is performed between the user and the exhibitor has the following problems. First, if the mediator intends to provide a negotiation site using the network by himself, it is necessary to establish his own negotiation system by himself and it is impossible to easily realize such a system in consideration of a development term and the costs. In the conventional negotiation system, the requesting side and the responding side are fundamentally persons, it is impossible to realize the automatization or semi-automatization, and it is laborious and it takes time to operate a negotiation. Further, the responder has to search the relevant category and respond to the negotiation site by himself. Moreover, since a negotiation of one article is carried out with respect to one item, for example, in case of establishing an office, the requestor has to determine necessary conditions one by one separately with respect to real estate, office stores, office equipment, and the like, prepare them, and thereafter, carry out a negotiation every item. Therefore, the process is laborious and takes time and the best choice is not guaranteed.

### SUMMARY OF THE INVENTION

The invention intends to provide a mediation negotiating method and a negotiation responding method whereby a negotiation field is formed in accordance with requesting conditions and an optimum negotiation result can be obtained from a large amount of response information and to provide a computer-readable recording medium in which a program for realizing such methods has been stored and a program thereof.

(Mediation Negotiating Method of Mediator Server)

According to the invention, there is provided a mediation negotiating method of mediating a negotiation between a requestor and responders by using a network, comprising:

a request forming step which forms requesting conditions in which priorities have been allocated to request contents in response to a mediating request of the requestor;

a negotiation requesting step which forms a negotiation field, inputs the requesting conditions, and notifies the requesting conditions to the responders selected in accordance with the requesting conditions; and

a negotiation responding step which receives response information from the responders who participate in the negotiation field and notifies the requester and the other responders of the received response information.

Therefore, if the requestor as a client issues a mediating request to a mediation negotiation server, requesting conditions corresponding to the mediating request are formed on the server side, a negotiation field is formed in a state where the responder of a backend server who requests has been selected, and the requestor can get the response information close to the best choice by seeing the negotiation field and decide a negotiation for narrowing down the specific responder.

Since the responder automatically receives a notification of the requesting conditions adapted to himself from the negotiation field, there is no need to search the requesting conditions adapted to his own category from the negotiation field. It is sufficient to form response information in response to the notified requesting conditions and return it to the negotiation field. Since the negotiation field is open to all participants, the requestor can always see the response information inputted to the negotiation field and decide the best choice while seeing a state of the responses to the requesting conditions. At the same time, the responder can always refer to the response information of other responders who are competitors inputted to the negotiation field and carry out a negotiation such that he issues his own responding conditions while observing attitudes of the competitors. Further, in the mediator, merely by providing the negotiation field to the requestor and the responder, the requestor can efficiently make the best choice and the responder can obtain a business chance such that he can decide the negotiation by bidding a number of requesting conditions. Thus, the mediator can relatively freely set a success reward, a registration fee, and an entry fee for the participants and obtain an opportunity for a stable and continuous income.

In the request forming step, a priority is allocated to the requested article or priorities are allocated to the request contents such as service, price, term of delivery, and the like and they are formed as requesting conditions. In this case, in the negotiation responding step, when the requester is notified of the response information inputted to the negotiation field, the response information arranged in accordance with the priorities of the request contents is notified. By allocating the priorities to the request contents and inputting them into the negotiation field as mentioned above, the following functions are obtained. First, by allocating the priorities to the request contents (request items) such as apparatus type, term of delivery, price, etc., the requestor can obtain the response information according to his own taste and carry out a negotiation. That is, he can preferentially negotiate with the partner corresponding to the item of the high priority and eliminate a vain negotiation with the partner who can make a response only to the item of the low priority. This means that it is possible to properly narrow down the negotiation partners. Since the notices from the negotiation field are sorted and given in order from the high priority, the requestor can promptly find out the optimum one of a plurality of response information. For example, if a priority is allocated to the term of delivery, notices sorted in order from the early term of delivery among a plurality of responses which satisfy the term of delivery are given. Further, a retry by a change in priority can be performed. Since the mediator fundamentally requests the requestor to set the priorities, a management regarding the priorities is fundamentally unnecessary. However, it is necessary to prepare default priority, non-setting of a priority, or the like. At a stage where the negotiation has been decided, the setting of the priorities of the decided request contents can be registered into the personal information file or the like and used upon formation of the requesting condition of the next time. Further, since the responder forms and inputs the response information according to the priorities specified in the requesting conditions, needs of the requestor can be clearly grasped. For example, the responder can form response information by beating his brains out in order to decide the negotiation of not only needs but also with a proposal exceeding the needs and input it into the negotiation field. For example, when the highest priority is allocated to the term of delivery, by presenting, for example, a delivery within the day or the like which is supposed to be impossible in such a business world, even if the price is high, there is a possibility that a transaction can be determined. In the request forming step, one or a plurality of requesting conditions are formed by analyzing an abstract mediating request from the requestor. For example, even in case of an uncertain, rough, and abstract mediating request from the user such as “wants to establish an office at a place near a station”, by analyzing it, specific requesting conditions are formed separately with respect to a category such as real estate, office stores, or office equipment through a designation of mediating condition list data or an inquiry of the user. A burden of inputting the requesting conditions by the requestor is remarkably reduced and a proper negotiation field to which know-how of the mediator has been reflected can be constructed.

In the negotiation requesting step, the request contents including the priorities in the requesting conditions inputted to the negotiation field are changed and inputted again. Therefore, the requestor sees the response information inputted to the negotiation field, and if the number of responses is small or desired response information is not obtained, by changing the request contents including the priorities and inputting them again, it is possible to cope with such a case by promoting the responder to input expected response information or the like. In the negotiation requesting step, if there are a plurality of requesting conditions, the responder is selected under a condition such that he corresponds to at least one of those requesting conditions, and a negotiation field between the responders and the requestor is formed. That is, in the invention, the responders are selected on a requesting condition unit basis and allowed to participate in the negotiation field. Therefore, even in case of specialist-like responders who provides specific articles or general responders who provide general articles, an opportunity for a bid to the negotiation field is uniformly given. In the negotiation requesting step, a negotiation term is set into the negotiation field and requesting conditions are inputted. In the negotiation responding step, the end of negotiation is discriminated and the negotiation field is closed. With respect to the closure of the negotiation field, in the negotiation responding step, the negotiation field is closed by a negotiation deciding instruction from the requestor or expiration of a negotiation term. In the negotiation responding step, the negotiation term can be extended on the basis of an instruction from the requester. In the negotiation responding step, the negotiation term can be also automatically extended if preset conditions are satisfied when the negotiation term expires. As conditions for automatic term extension, for example, there is a case where there is no response information or the number of response information is less than a predetermined threshold value at the time of the expiration of the negotiation term.

(Recording Medium for Mediator Server)

The invention provides a computer-readable recording medium in which a mediation negotiation program has been stored, wherein the mediation negotiation program comprises:

a request forming step which forms requesting conditions in which priorities have been allocated to request contents in response to a mediating request of a requester;

a negotiation requesting step which forms a negotiation field, inputs the requesting conditions, selects responders corresponding to the requesting conditions, and notifies the responders of the requesting conditions; and

a negotiation responding step which receives response information from responders who participate in the negotiation field and notifies the requestor and the other responders of the received response information.

(Program for Mediator Server)

The invention provides a mediation negotiating program which causes a computer to execute:

a request forming step which forms requesting conditions in which priorities have been allocated to request contents in response to a mediating request of the requestor;

a negotiation requesting step which forms a negotiation field, in puts the requesting conditions, and notifies the requesting conditions to the responders selected in accordance with the requesting conditions; and

a negotiation responding step which receives response information from the responders who participate in the negotiation field and notifies the requestor and the other responders of the received response information.

(Bid Price Changing Method of Responder Server)

The invention provides a bid price changing method of a responder server for dynamically changing a bid price in a negotiation field, comprising:

a receiving step which receives request information inputted into the negotiation field formed on a network; and

a negotiation responding step which prepares an initial value, a pitch value, and a lowest value with respect to the bid price, first inputs response information in which the initial value has been set to the bid price, in the case where another response information of a cheap bid price is recognized in the negotiation field, again inputs response information in which the bid price has sequentially been corrected on a unit basis of the pitch value, and in the case where bid price of a competitor is lower than the lowest value, stops the input of the response information and breaks off the negotiation.

Also in the invention, a change and a correction of the response information responsive to, for example, the bid price presented by the competitor in the negotiation field are fundamentally performed by a person. However, by predetermining the conditions, the bid price and the term of delivery are automatically corrected, so that it is possible to compete.

(Recording Medium for Responder)

The invention further provides a computer-readable recording medium in which a bid price changing program for a responder server for dynamically changing a bid price in a negotiation field has been stored, wherein the bid price changing program comprises:

a receiving step which receives request information inputted into the negotiation field formed on a network; and

a negotiation responding step which prepares an initial value, a pitch value, and a lowest value with respect to the bid price, first inputs response information in which the initial value has been set to the bid price, in the case where another response information of a cheap bid price is recognized in the negotiation field, again inputs response information in which the bid price has sequentially been corrected on a unit basis of the pitch value, and in the case where a bid price of a competitor is lower than the lowest value, stops the input of the response information and breaks off the negotiation.

(Program for Responder Server)

In addition, the invention provides a bid price changing program for a responder server for dynamically changing a bid price in a negotiation field, wherein:

the program causes a computer to execute:

a receiving step which receives request information inputted into the negotiation field formed on a network; and

a negotiation responding step which prepares an initial value, a pitch value, and a lowest value with respect to the bid price, first inputs response information in which the initial value has been set to the bid price, in the case where another response information of a cheap bid price is recognized in the negotiation field, again inputs response information in which the bid price has sequentially been corrected on a unit basis of the pitch value, and in the case where a bid price of a competitor is lower than the lowest value, stops the input of the response information and breaks off the negotiation.

The above and other objects, features, and advantages of the present invention will become more apparent from the following detailed description with reference to the drawings.

### BRIEF DESCRIPTION OF THE DRAWINGS

FIGS. 1A and 1B are explanatory diagrams of a network system to which a mediation negotiating method of the invention is applied;

FIG. 2 is a flowchart for a processing procedure of the mediation negotiating method of the invention;

FIGS. 3A and 3B are conceptual explanatory diagrams of a negotiation requesting process and a negotiation responding process in a mediation negotiation of the invention;

FIG. 4 is an explanatory diagram of a business model according to the mediation negotiating method of the invention;

FIGS. 5A and 5B are explanatory diagrams of a business model according to the mediation negotiating method of the invention with respect to an office establishing service as an example;

FIGS. 6A to 6C are explanatory diagrams of requesting condition data in which priorities have been allocated to request contents;

FIG. 7 is an explanatory diagram of specific requesting condition data in which priorities are sequentially set in a describing order;

FIG. 8 is an explanatory diagram of specific requesting condition data in which priorities are described in existing tags;

FIG. 9 is an explanatory diagram of specific requesting condition data in which tags for priorities are added;

FIG. 10 is an explanatory diagram of a mediating condition list file in FIGS. 1A and 1B;

FIG. 11 is an explanatory diagram of a mediation menu picture plane which is presented to the user;

FIG. 12 is an explanatory diagram of a personal information file in FIGS. 1A and 1B;

FIGS. 13A and 13B are detailed flowcharts for a requesting condition forming process in FIGS. 1A and 1B;

FIGS. 14A and 14B are flowcharts for the negotiation requesting process and the negotiation responding process in FIGS. 3A and 3B;

FIG. 15 is a flowchart for a term monitoring process of a negotiation field of the invention;

FIGS. 16A and 16B are flowcharts for a responder process for automatically changing a bid price in response to a presented price of a competitor;

FIG. 17 is an explanatory diagram of a work introducing model of small and medium enterprises using the invention;

FIG. 18 is an explanatory diagram of a professional association model using the invention; and

FIG. 19 is an explanatory diagram of a wholesaler model using the invention.

### DETAILED DESCRIPTION OF THE PREFERRED EMBODIMENS

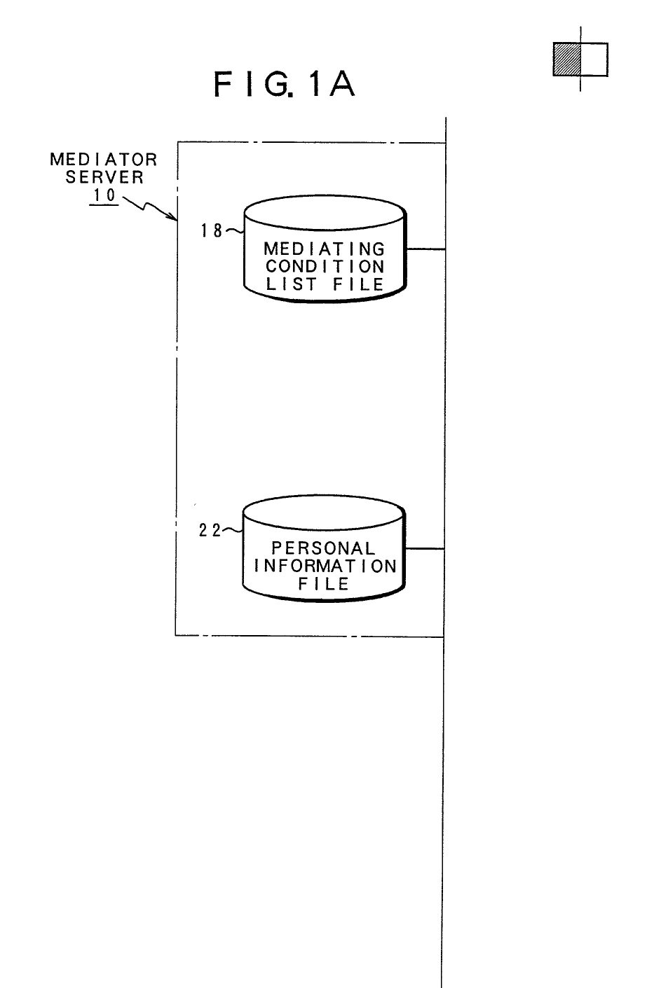

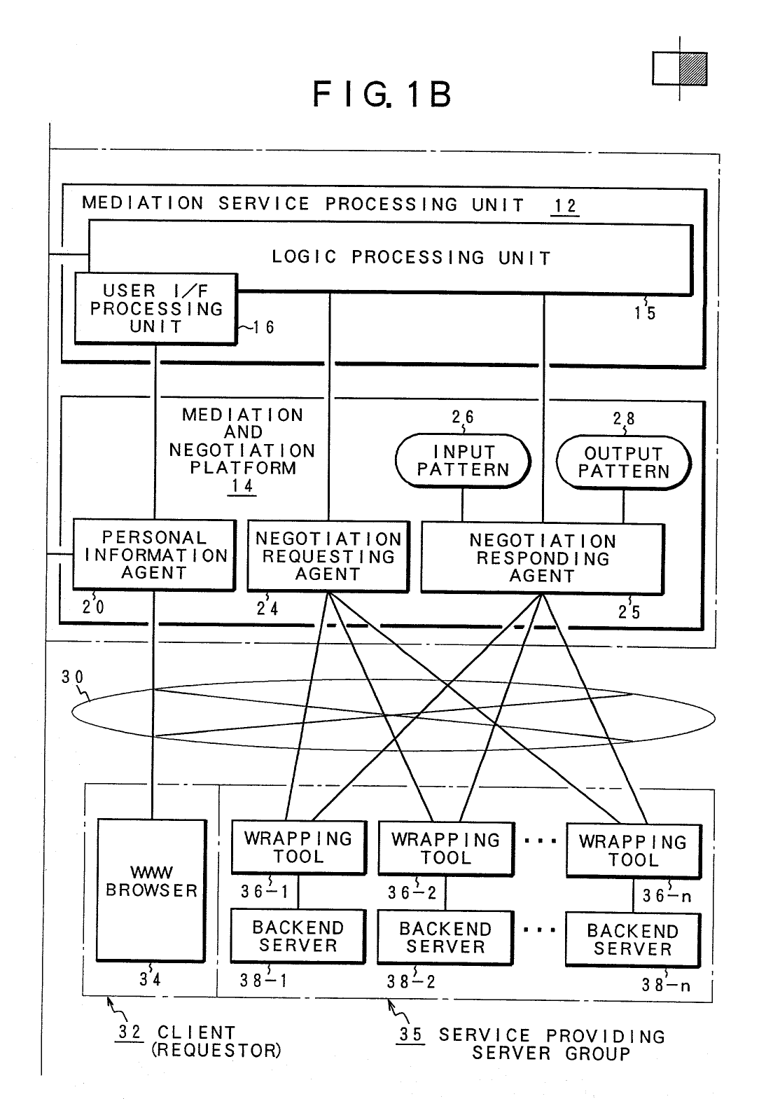

FIGS. 1A and 1B are explanatory diagrams of a network system to which a mediation negotiating method of the invention is applied. A program function for realizing the mediation negotiating method of the invention is provided for a mediator server 10. The mediator server 10 has a mediation service processing unit 12 and a mediation and negotiation platform 14. The mediation service processing unit 12 comprises a logic processing unit 15 and a user interface processing unit 16. A mediating condition list file 18 is connected to the logic processing unit 15. The mediation and negotiation platform 14 is a platform including a plurality of agent groups. In the mediation negotiating method of the invention, the mediation and negotiation platform 14 has a personal information agent 20, a negotiation requesting agent 24, and a negotiation responding agent 25. A personal information file 22 is connected to the personal information agent 20. A WWW browser 34 of a client 32 serving as a requestor side is connected to the personal information agent 20 through a network 30 such as Internet, Intranet, or the like. Backend servers 38-1, 38-2, . . . , and 38-n which function as responder servers provided for a service providing server group 35 through the network 30 are connected to the negotiation requesting agent 24 and negotiation responding agent 25 of the mediation and negotiation platform 14 via wrapping tools 36-1, 362, . . . , and 36-n, respectively. For example, now considering a case where the requestor requests a mediator server for establishing an office, the backend servers 38-1 to 38-n functioning as responder servers are servers possessed by responders who handle real estate, office furniture, office equipment, and the like which are necessary for establishing an office. The wrapping tools 36-1 to 36-n provided for the backend servers 38-1 to 38-n are programs for performing cooperation between the specific server requesting conditions from the negotiation requesting agent 24 and negotiation responding agent 25 on the mediation and negotiation platform 14 side and the backend servers 38-1 to 38-n, and constructed every kind of backend servers 38-1 to 38-n. The wrapping tools 36-1 to 36-n can be also provided on the mediation and negotiation platform 14 side. As examples of the wrapping tools 36-1 to 36-n, for instance, requesting conditions from the mediation and negotiation platform 14 side, for example, a discount corresponding logic in the case where another competitive company appears for the same article, and the like are constructed.

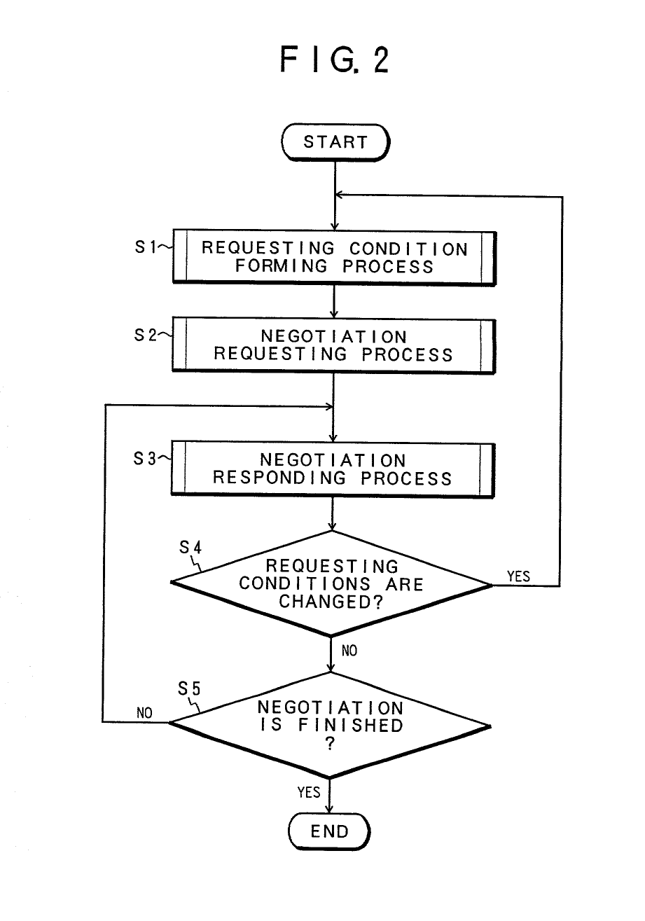

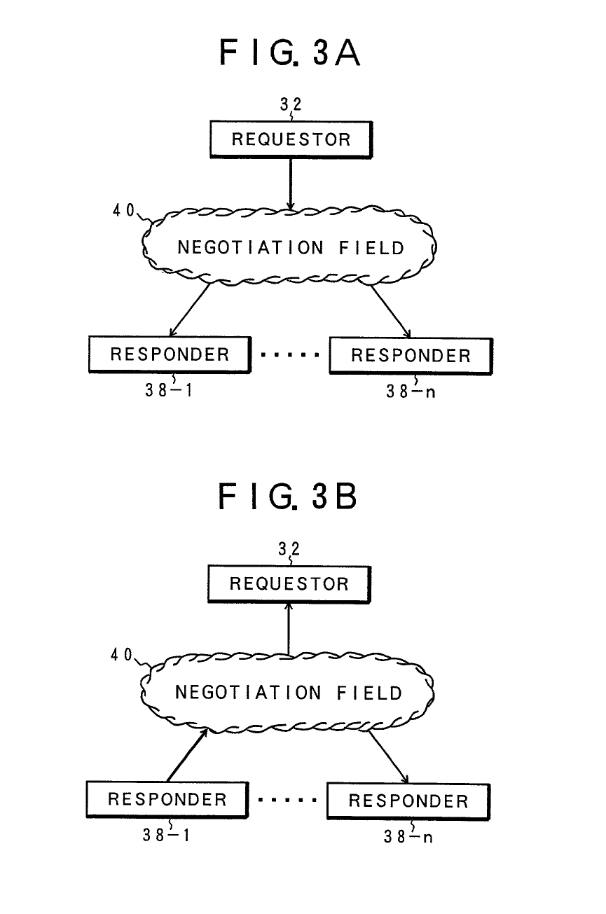

FIG. 2 is a flowchart showing a processing procedure of a mediation negotiating method of the invention which is executed by the network system of FIGS. 1A and 1B. In the mediation negotiating method of the invention, first, in step S1, the mediation service processing unit 12 of the mediator server 10 forms requesting conditions in which priorities have been allocated to request contents in response to a mediating request of the requestor who uses the WWW browser 34 of the client 32. With respect to the requesting condition forming process, in the invention, specific requesting conditions to the backend servers 38-1 to 38-n which actually provide response information of a negotiation can be formed in response to an uncertain, rough, and abstract request from the requester. In order to form the specific requesting conditions in response to such an abstract mediating request, the mediating condition list file 18 and the personal information file 22 via the personal information agent 20 are provided for the mediation service processing unit 12. When the requesting condition forming process is finished in step S1, the formed requesting conditions are notified to the negotiation requesting agent 24 of the mediation and negotiation platform 14, and a negotiation requesting process is performed. According to the negotiation requesting process, as shown in FIG. 3A, a negotiation field 40 serving as a site for a negotiation is formed for the client 32 as a requestor and the backend servers 38-1 to 38-n as responders, and the formed requesting conditions are inputted into the negotiation field 40. Ones of the backend servers 38-1 to 38-n as responders which enable the response according to the requesting conditions inputted into the negotiation field 40 are selected, and the corresponding responder is notified of only the requesting conditions adapted to the matched responding conditions. The negotiation requesting agent 24 in FIGS. 1A and 1B executes the formation of the negotiation field 40 based on the requesting conditions and the input of the requesting conditions. The negotiation responding agent 25 executes the selection of the responder and the notification of the requesting conditions. The negotiation responding agent 25 has an input pattern file 26. Input patterns for extracting the respondable requesting conditions have been set in the input pattern file 26 separately for each of the backend servers 38-1 to 38-n as responders. Therefore, when the notification of the requesting conditions inputted into the negotiation field is received, the negotiation responding agent 25 compares the requesting conditions and the input pattern for each responder in the input pattern file 26 and notifies the backend servers as a relevant responder of the requesting conditions adapted to the input pattern.

When the negotiation requesting process is finished in step S2 in FIG. 2, the negotiation responding process is executed in step S3. FIG. 3B shows an outline of the negotiation responding process. In the negotiation responding process, the response information formed in accordance with the requesting conditions from the backend server as a responder who participates in the negotiation field 40, for example, from the backend server 38-1 is inputted into the negotiation field 40 and the inputted response information is notified to the client 32 as a requestor and the backend servers 38-2 to 38-n as other responders. The negotiation responding agent 25 in FIGS. 1A and 1B executes the negotiation responding process. The negotiation responding agent 25 monitors the reception of the response information from the backend servers 38-2 to 38-n to which the requesting conditions were notified. When the response information is received, the agent 25 forms response information in accordance with an output pattern which has been preset in an output pattern file 28 and inputs the formed response information into the negotiation field 40. The response information inputted into the negotiation field 40 as mentioned above is notified to the client 32 as a requestor by the negotiation requesting agent 24 and, at the same time, notified also to the backend servers 38-2 to 38-n serving as other requesters. Therefore, the requesting conditions and response information which are inputted into the negotiation field 40 serving as a site for a negotiation become information which can be freely seen by all participants. In case of notifying the requestor of the response information, the negotiation requesting agent 24 sorts a plurality of response information in accordance with the priorities allocated to the requesting conditions and notifies.

The requester on the client 32 side who received the notification of the response information inputted into the negotiation field by the negotiation responding process in step S3 in FIG. 2 can select the optimum response information adapted to his own conditions from a number of response information displayed by the WWW browser 34. If the optimum response information can be selected as mentioned above, the negotiation field is closed by issuing a negotiation decision instruction from the client 32 to the mediator server 10. Cooperation with another system such as an ordering system or the like is made and the backend server of the responder is notified of the negotiation decision with respect to the decided negotiation result. Until the requestor issues the negotiation decision instruction by the client 32, an assumed name security of the responder of the response information inputted into the negotiation field is held. At a stage when the negotiation decision instruction is issued, a background of the responder of the relevant response information is clarified. Further, in the mediation negotiating process in FIG. 2, whether there is a change in requesting conditions during the negotiation responding process in step S3 or not is discriminated in step S4. That is, all response information inputted into the negotiation field by the negotiation responding process can be seen on the requestor side. If the response information having the contents with which the requestor is satisfied is not inputted into the negotiation field or if no response information is inputted or the number of response information is too small, the requester can instruct the mediator server 10 to change the requesting conditions through the client 32. If there is such a changing instruction of the requesting conditions, the processing routine is returned to the requesting condition forming process in step S1. The mediator server 10 forms the corrected requesting conditions in consideration of the change in conditions or the like from the requestor. After the formation of the corrected requesting conditions, the negotiation requesting process in step S2 and the negotiation responding process in step S3 are retried. As a specific change in the requesting conditions, for example, it is sufficient to change the priorities allocated to the request contents or issue an instruction to relax various conditions.

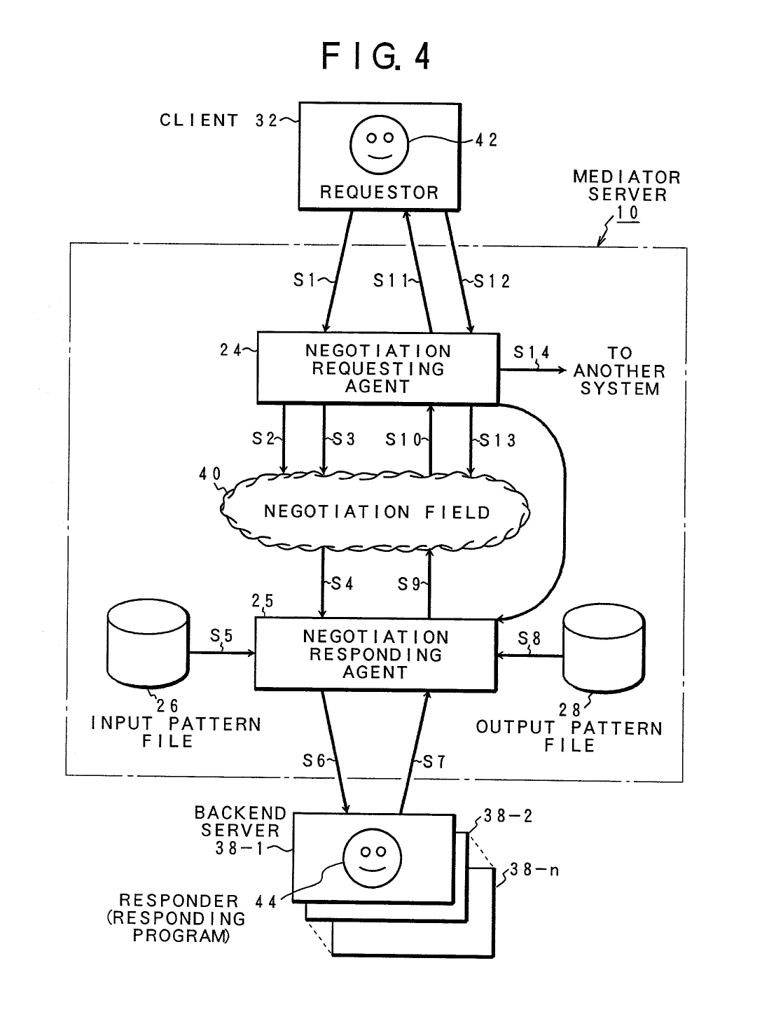

FIG. 4 is an explanatory diagram of a business model which is realized by the mediation negotiating process in FIG. 2. The business model constructed by the mediation negotiating method of the invention comprises: the client 32 which is used by a requestor 42; the negotiation requesting agent 24 existing in the mediator server; the negotiation field 40; the negotiation responding agent 25 having the input pattern file 26 and output pattern file 28; and a responder 44 who uses the backend servers 38-1 to 38-n. Besides a person, the responder 44 can be also realized as a function according to a responding program. A processing procedure of the business model in FIG. 4 is as shown in steps SI to S15. When the requesting conditions formed by the mediating request from the requestor 42 who uses the client 32 are given to the negotiation requesting agent 24 in step S1, the negotiation responding agent 25 as a request destination is selected and the negotiation field 40 serving as a site for a negotiation is formed in step S2. Requesting conditions are inputted into the negotiation field 40 in step S3. The negotiation responding agent 25 is notified of the requesting conditions inputted into the negotiation field 40 in step S4. In step S5, the negotiation responding agent 25 reads out the input pattern for each responder from the input pattern file 26 and collates it with the requesting conditions. In step S6, for example, the backend server 38-1 of the responder 44 and the other backend servers are notified of only the requesting conditions adapted to the input pattern. When the requesting conditions are notified, the priorities of the request contents are shown. The processes in steps S1 to S6 correspond to the negotiation requesting process in step S2 of the flowchart of FIG. 2. Subsequently, the responder 44 of, for example, the backend server 38-1 who received the notification of the requesting conditions forms response information in consideration of the priorities of the shown request contents, and responds to the negotiation responding agent 25 in step S7. The negotiation responding agent 25 which received the response from the responder 44 forms response information according to output patterns which have been preset in the output pattern file 28 and inputs it into the negotiation field 40 in step S9. In step S10, the negotiation requesting agent 24 is notified of the response information inputted into the negotiation field 40. In step S11, the client 32 of the requestor 42 is further notified of the response information. At this time, if a plurality of requesting conditions have been inputted into the negotiation field 40, the response information is notified in a form such that it has been sorted in accordance with the priorities of the request contents. If it is optimum as compared with the other response information, the requester 42 who observed the response information issues a negotiation decision instruction to finish the negotiation to the negotiation requesting agent 24 in step S12. The negotiation requesting agent 24 who received the negotiation decision instruction closes the negotiation field 40 in step S13. The requestor 42 cooperates with another system such as an ordering system or the like in step S14 and, thereafter, finally issues a negotiation decision notification to the negotiation responding agent 25 in step S15, so that a series of mediation negotiation is finished. The processes in steps S14 and S15 can be also reversed. When the negotiation requesting agent 24 inputs the requesting conditions into the negotiation field 40 in step S3, a timer in which a predetermined negotiation term has been set is activated. When the time counted by the timer expires the negotiation term, the negotiation field 40 is closed in principle. The negotiation term which is set to close the negotiation field 40 can be extended as necessary. The extension of the negotiation term can be performed by an instruction from the requestor or can be also automatically performed when predetermined requesting conditions are satisfied.

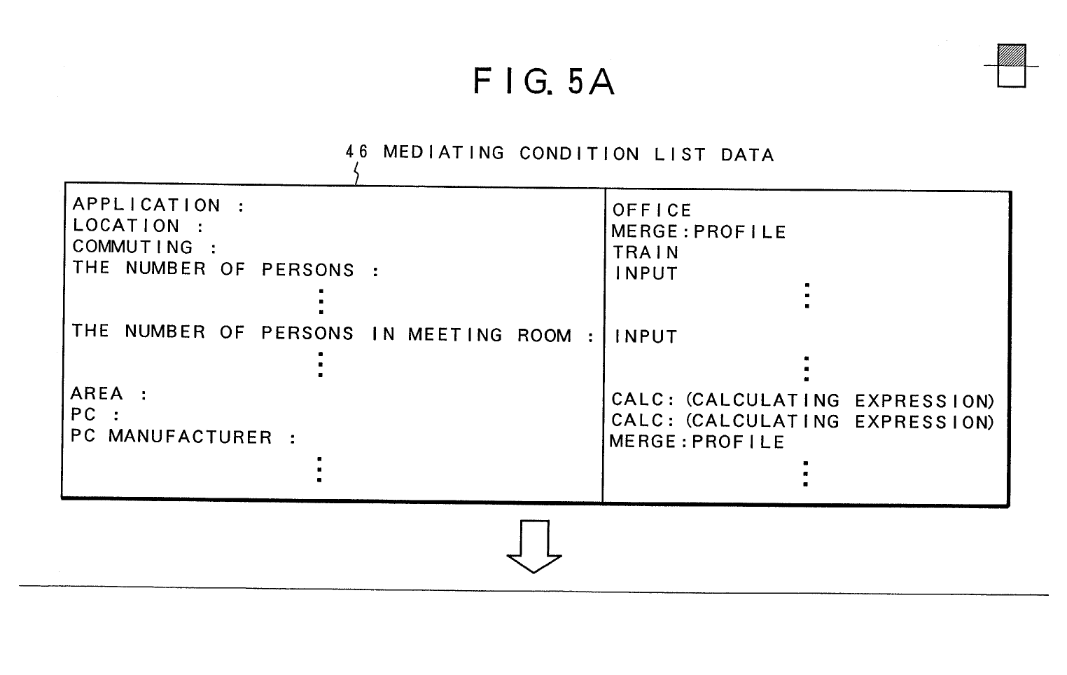

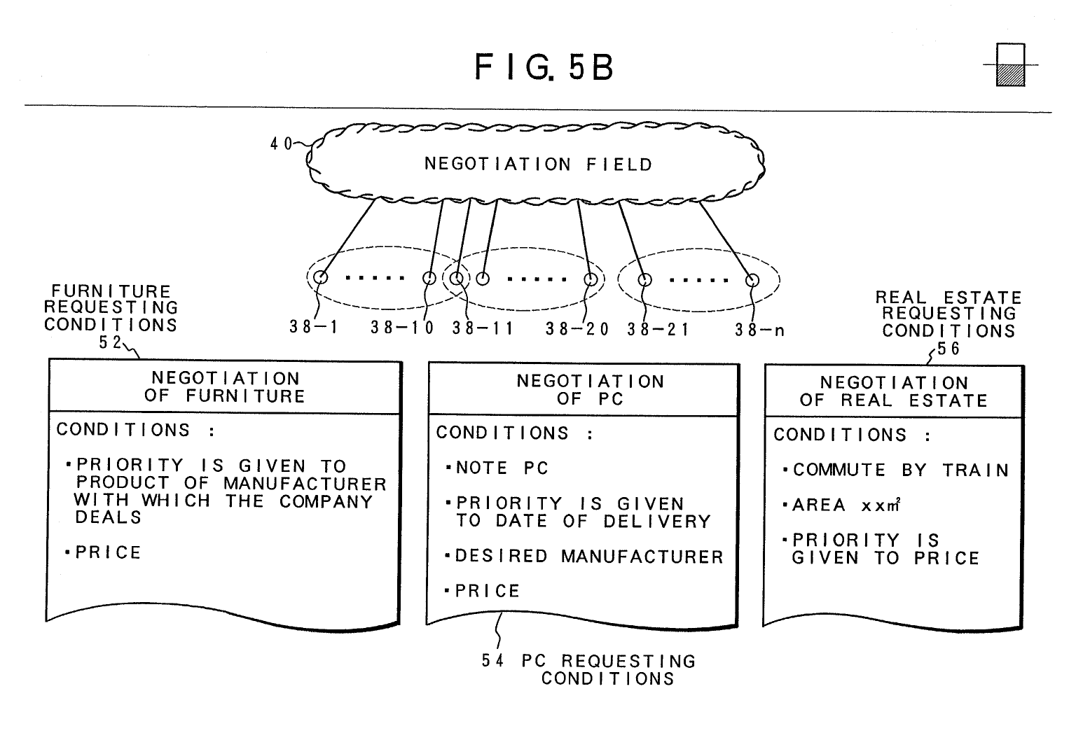

FIGS. 5A and 5B show a specific example of the mediation negotiating method of the invention in response to a mediating request for a service to establish an office from the requestor. According to mediating condition list data 46, request contents of the office establishing service are separately formed with respect to an application, a location, commuting, the number of persons, the number of persons in a meeting room, an area, a personal computer (PC), a PC manufacturer, and the like. As for the mediating condition list data 46, as will be clarified in an explanation later, in response to an uncertain, rough, and abstract mediating request, “wants to establish an office at a place near a station” of the requester, the mediation service processing unit 12 provided for the mediator server 10 in FIGS. 1A and 1B forms the mediating condition list data 46 serving as specific requesting conditions for the backend servers 38-1 to 38-n as responder servers via the mediating condition list file 18 or via the personal information file 22 through the personal information agent 20. The mediating condition list data 46 formed as mentioned above is divided into requesting conditions in which priorities have been allocated to condition contents, inputted into the negotiation field 40, and notified to the backend servers 38-1 to 38-n side adapted to the requesting conditions. For example, if the data 46 is divided into three requesting conditions such as furniture requesting conditions 52, PC requesting conditions 54, and real estate requesting conditions 56, with respect to the furniture requesting conditions 52, the backend servers 38-1 to 38-11 are selected by collation with the input pattern and notified. With respect to the PC requesting conditions 54, the backend servers 38-11 to 38-20 are selected and notified. Further, with respect to the real estate requesting conditions 56, the backend servers 38-21 to 38-n are selected and notified. Among them, in the backend server 38-11, since the conditions of the input pattern are matched with both of the furniture requesting conditions 52 and PC requesting conditions 54, it is notified of the two requesting conditions. As mentioned above, since the backend servers 38-1 to 38-n are notified every requesting condition inputted into the negotiation field 40, even special responders who make a specific response or general responders who can respond to a plurality of request information can obtain a business chance of a negotiation by the notification of the requesting conditions according to each trader. A plurality of request contents are included in the requesting conditions which are notified to the backend servers 38-1 to 38-n. For example, in the requesting conditions corresponding to the negotiating conditions 54 of PC, a type, a term of delivery, a manufacturer, a price, and the like are listed as request contents. In the invention, priorities are allocated to the request contents with respect to the requesting conditions which are inputted into the negotiation field 40. The response information corresponding to the priority is formed and the requester is notified of the response information.

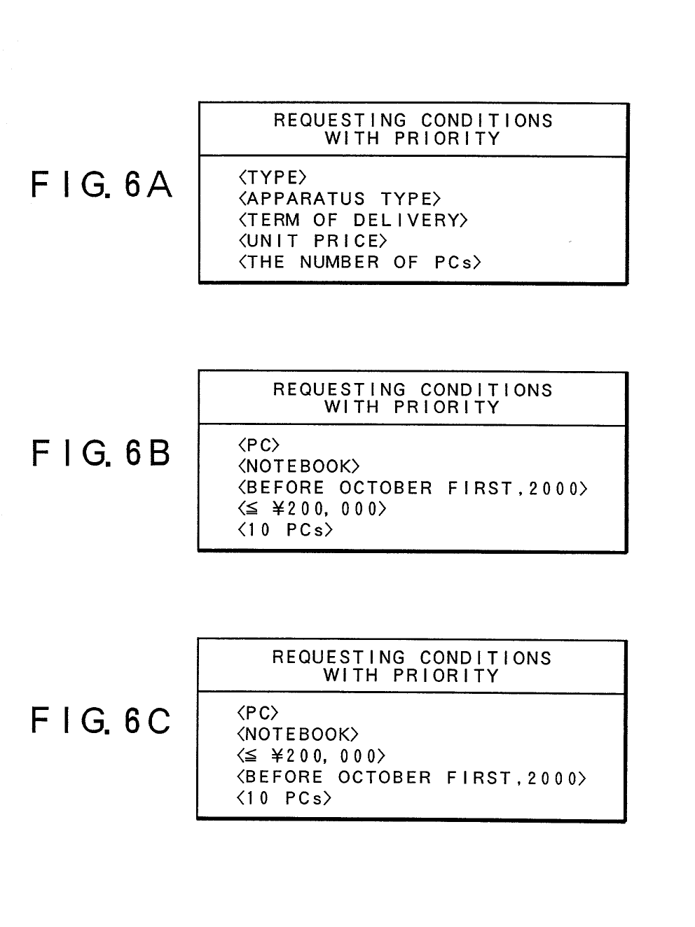

FIGS. 6A to 6C are explanatory diagrams of the requesting conditions with priorities which are inputted into the negotiation field 40. FIG. 6A shows a fundamental structure of requesting condition data with priorities with respect to the request of the PC in FIGS. 5A and 5B as an example. A type, an apparatus type, a term of delivery, a unit price, and the number of PCs are listed as request contents. The priorities are set in order of the listed PCs. FIG. 6B shows a specific example of the requesting condition data with priorities. For example, the type is set to “PC”, the apparatus type is set to “notebook”, the term of delivery is set to “before October 1st, 2000”, the unit price is set to “¥200,000”, and further, the number of PCs is set to “10”. The priorities of the request contents in such requesting conditions can be arbitrarily changed by changing, for example, describing positions as shown in FIG. 6C.

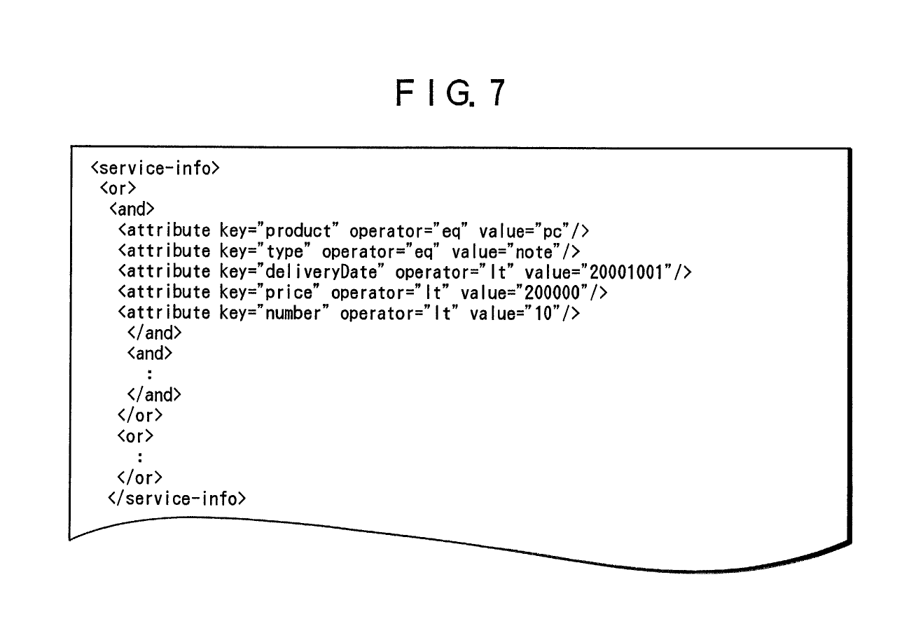

FIG. 7 shows a specific example of the requesting condition data with priorities and shows a description example of XML. This description example shows an XML description corresponding to the requesting condition data with priorities in FIG. 6B and the priorities are set to the request contents in describing order.

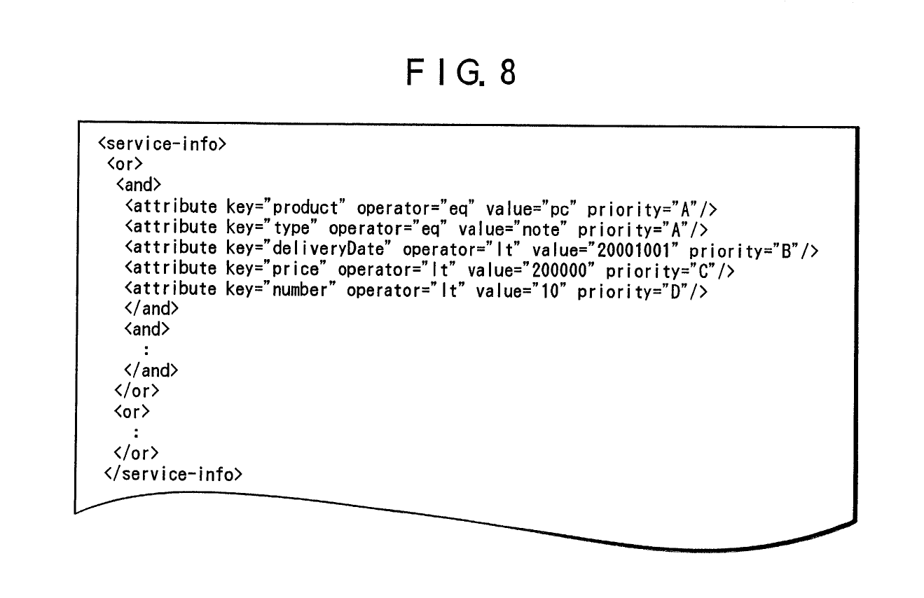

FIG. 8 shows another specific example of requesting condition data with priorities by the XML description. A description of the priorities is added to existing tags. That is, the contents of the requesting condition data with priorities correspond to FIG. 6B and “A, B, C, D” are added as priorities to the tags in describing order.

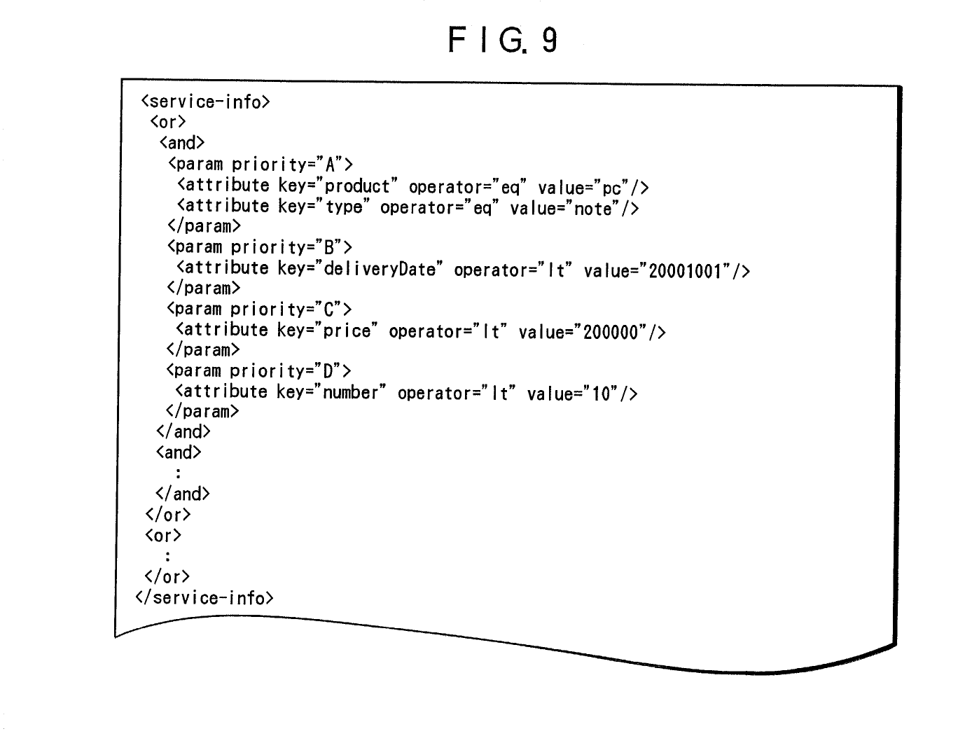

FIG. 9 shows the third specific example of the requesting condition data with priorities by the XML description. In this example, <param priority=“A” . . . “D”> is added as tags for the priorities every line. A describing method of the requesting condition data with priorities is not limited to the expressing method of XML of each of FIGS. 7 to 9 but can have an arbitrary form according to an adapting situation of the actual system so long as a language which becomes an article is unified.

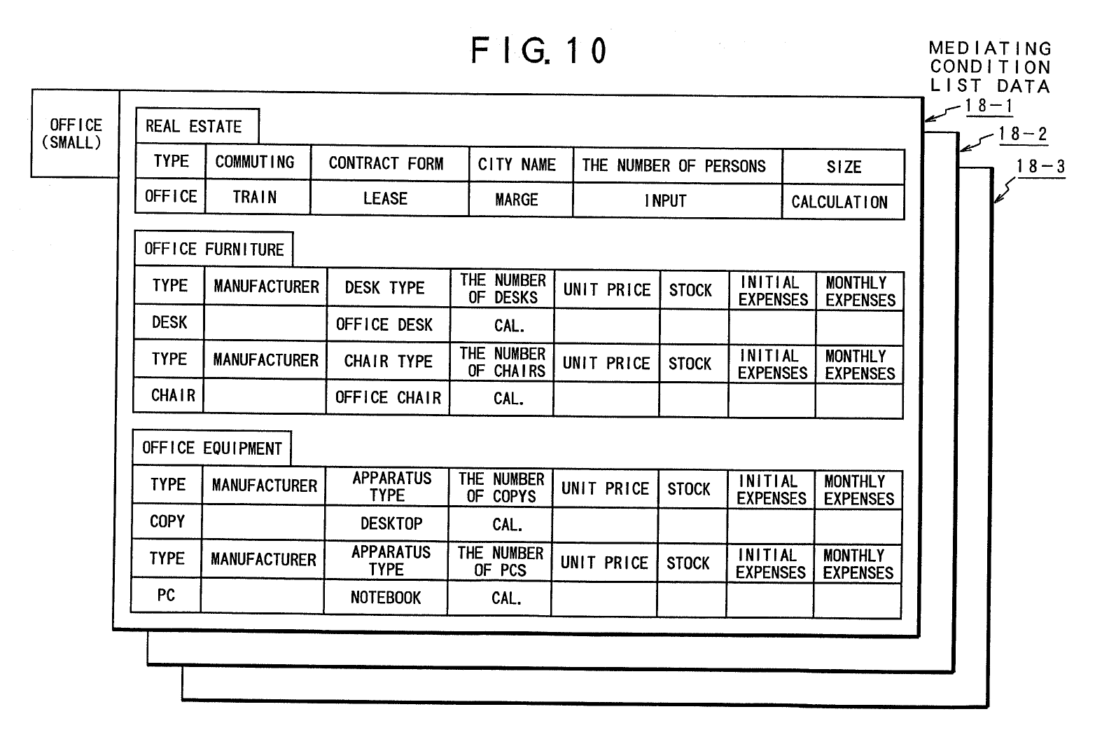

A forming process of requesting conditions by the mediation service processing unit 12 in FIGS. 1A and 1B will now be described. The mediation service processing unit 12 has a function for forming specific requesting conditions from an uncertain, rough, and abstract request for the mediator server 10 by the requestor using the client 32. FIG. 10 shows an example of mediating condition list data for converting the uncertain, rough, and abstract request of “wants to establish an office at a place near a station” from the user into a specific request for the backend servers 38-1 to 38-n. The mediator server 10 presumes such an abstract request of “wants to establish an office at a place near a station”, uses his own mediation know-how, for example, classifies an office scale into three scales of large, middle, and small, and prepares mediating condition list data 18-1 for a small office, mediating condition list data 18-2 for a middle office, and mediating condition list data 18-3 for a large office. As for the three kinds of mediating condition list data 18-1 to 18-3, as shown in the mediating condition list data 18-1 for a small office, mediation items are classified into the following three items

(I) real estate

(II) office furniture

(III) office equipment

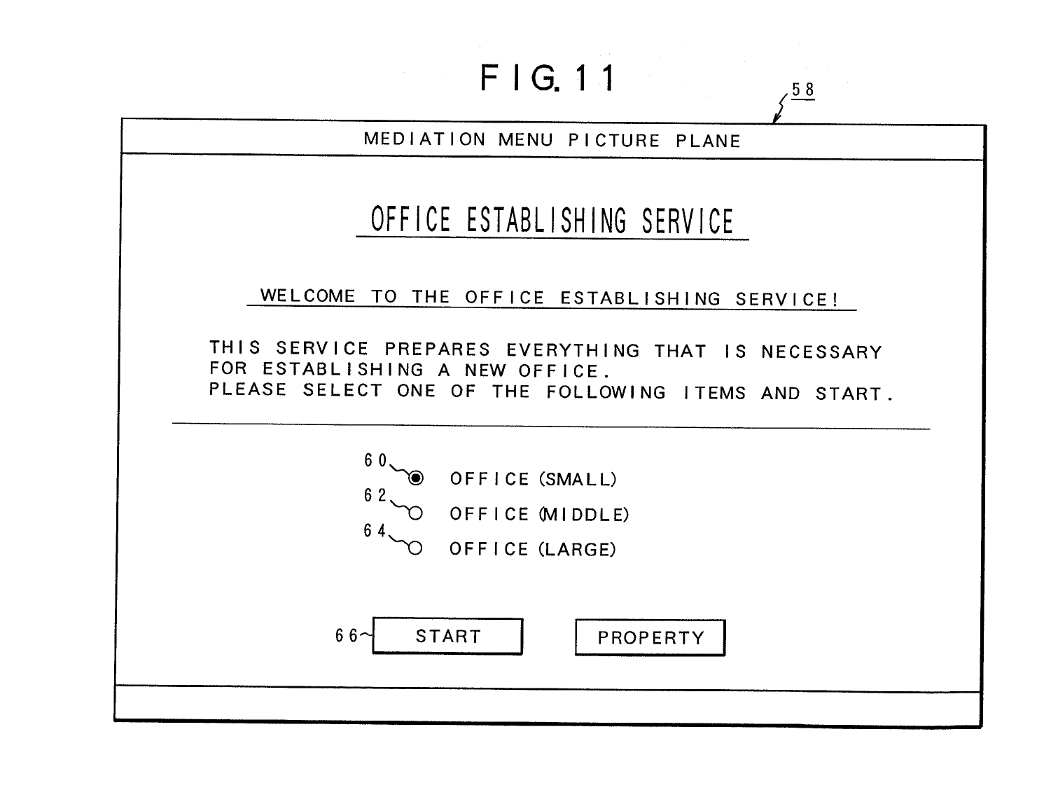

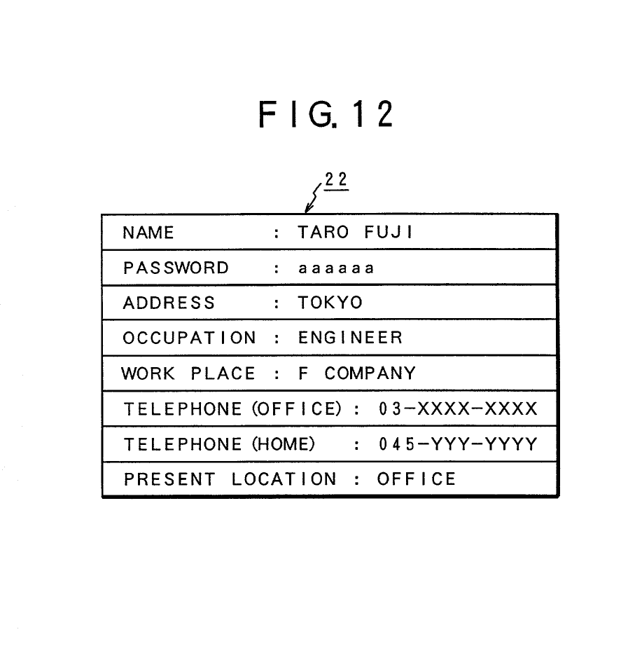

and specific mediating conditions are described. For example, in case of the head mediation item “real estate”, a type, a commuting, a contract type, a city name, the number of persons, and a size are described. On the basis of the know-how of the mediator responders, the type is set to “office” and a user request for commuting indicates “place near a station”, that is, a location where the user can commute on foot from a station. Therefore, commuting by train is set as “train”. The contract type is set to “lease”. As for the next city name, since it is determined from the personal information peculiar to the user with reference to the personal information file 22, which will be explained hereinlater, for example, “MARGE” is set as a code indicative of the reference of the personal information. Since it is necessary to inquire of the user about the number of persons, a code “INPUT” indicative of a user inquiry is stored. Further, as for a size indicative of an office area, if “the number of persons” inquired of the user is decided, the office size, that is, a floorage is determined by a predetermined calculating expression. Therefore, a code “CALCULATION” showing that it is set by the calculating expression is set. As for the next “office furniture”, items of a type, a manufacturer, a desk type, the number of desks, a unit price, a stock, initial expenses, and monthly expenses (running costs) are provided. They are set to the type “desk” and desk type “office desk” which have been known in accordance with the know-how of the mediator responders. As for the number of desks, since it is determined from the number of persons that is decided by the user inquiry about the first item “real estate”, a code “CAL.” showing that it can be obtained by a calculating expression is set. With respect to the other items such as manufacturer, unit price, stock, initial expenses, and monthly expenses, since they become service providing information which is obtained by actually inputting the mediating conditions to the backend servers 38-1 to 38-n, they are set to blank areas. This point is also similarly applied to the next type “desk”. Also with respect to the third mediation item “office equipment”, “copy” and “PC” are fixedly set as shown in the type. Also with regard to the apparatus type which is decided by the know-how of the mediator responders, “desktop” and “notebook” are fixedly set. The number of PCs is set so that it can be obtained by a calculating expression. Since the other items are determined by actually notifying the backend servers 38-1 to 38-n of the requesting conditions from the negotiation field, they are set to blank areas. When the abstract mediating request of “wants to establish an office at a place near a station” is received from the user using the client 32 provided with the WWW browser 34, the logic processing unit 15 provided for the mediation service processing unit 12 in FIGS. 1A and 1B analyzes the abstract request of the user and recognizes a fact that it is a request for establishment of an office. A mediation menu picture plane 58 as shown in FIG. 11 for allowing the user to select an office scale and request a mediation is formed by an HTML forming mechanism by the user interface processing unit 16 and displayed by the WWW browser 34 of the client 32. Check boxes 60, 62, and 64 corresponding to three kinds of office establishing requests of a small scale, a middle scale, and a large scale are provided for the mediation menu picture plane 58 in FIG. 11. If the user desires an office of, for example, a small scale, he clicks the check box 60 and presses a start button 66. In response to it, the logic processing unit 15 reads out the mediating condition list data 18-1 for a small office in FIG. 10 from the mediating condition list file 18 and converts the abstract user request into requesting conditions serving as specific requests for the backend servers 38-1 to 38-n. When the logic processing unit 15 reads out the specific mediating condition list data corresponding to the abstract user request from the mediating condition list file 18, a process for deciding lacking conditions in the mediating condition list data by the reference to the personal information file 22 or the inquiry of the user from the client 32 is performed. In the mediating condition list data 18-1 for a small office in FIG. 10, the reference code “MARGE” to designate the reference to the user personal information has been stored in “city name” in the head mediation item “real estate”. Therefore, the logic processing unit 15 inquires of the personal information agent 20 provided for the mediation and negotiation platform 14 about the personal information of the user who issued the mediating request. Now, assuming that the name of the user who issued the mediating request is, for example, “Taro Fuji”, the personal information file 22 as shown in FIG. 12 has previously been registered in correspondence to Taro Fuji into the personal information file 22 which is managed by the personal information agent 20. A name, a password, an address, an occupation, a work place, telephones (office and home), and further, a present location have been stored in the personal information file 22. Therefore, in response to an inquiry of the user about the city name via the logic processing unit 15, the personal information agent 20 responds “Tokyo” as an address in the personal information file 22. Thus, “Tokyo” is set as a city name in “real estate”.

With respect to “the number of persons” in the mediation item “real estate”, the logic processing unit 15 subsequently inquires of the client 32 about the number of persons upon establishment of an office from the WWW browser 30 by using the HTML forming function in the user interface processing unit 16 on the basis of the inquiry code “INPUT”. When the user responds the number of persons to the inquiry, the inquiry code “INPUT” is rewritten to the number of persons answered by the user. When the answer about the number of persons in the office is derived from the user, by substituting the number of persons answered by the user into a calculating expression which has been preset in correspondence to a next calculation code “CALCULATION”, a size of office is calculated. Further, with respect to the second and third mediation items “office furniture” and “office equipment”, a numerical value of the number of persons obtained as an answer from the user is set in the mediation item “real estate” with respect to a calculation code “CAL.” of “the number of - - - ”. All of the mediating condition list data 18-1 serving as a set of specific requesting conditions for the backend servers 38-1 to 38-n is decided by the inquiry about the personal information, user inquiry, and further, calculating processes as mentioned above.

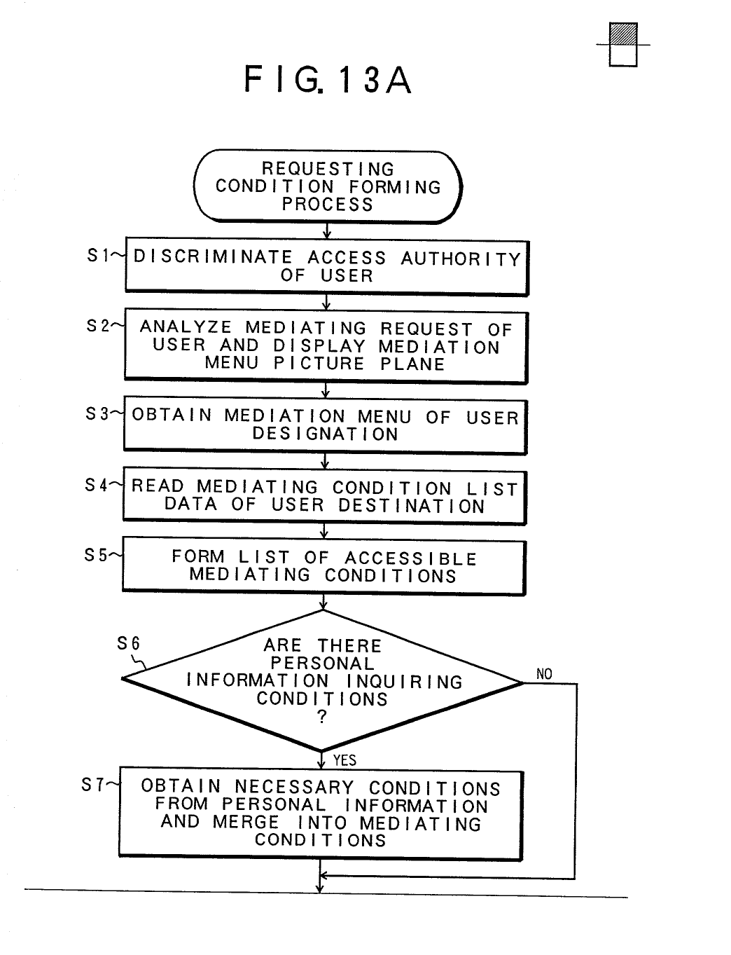

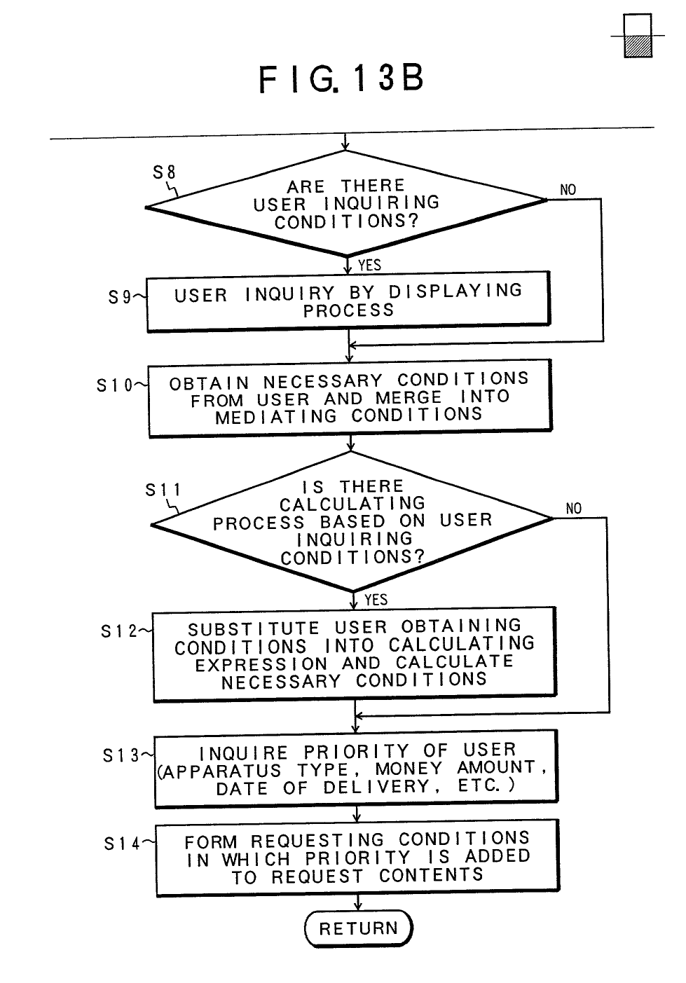

FIGS. 13A and 13B are an example of a flowchart for the requesting condition forming process by the mediation service processing unit 12 provided for the mediator server 10 in FIGS. 1A and 1B. When the user issues an abstract mediating request to the mediator server 10 by using the WWW browser 34 of the client 32, first, in step S1, the personal information of the user is obtained from the personal information file 22 by the personal information agent 20 and an access authority of the user is discriminated from, for example, a password “aaaaaa” of the user included in the personal information 22 as shown in FIG. 12. Subsequently, in step S2, the abstract mediating request from the user is analyzed and a mediation menu picture plane corresponding to it is displayed as shown in, for example, FIG. 12. When the user selects the menu on the mediation menu picture plane, a mediation menu of the user designation is obtained in step S3. Mediating condition list data of the user designation is read out from the mediating condition list file 18 in step S4. Subsequently, accessible mediating condition list data is formed for the backend servers 38-1 to 38-n in step S5. If there is a personal information inquiring item in the mediating condition list data in step S6, the necessary conditions are obtained from the personal information file 22 by inquiring of the personal information agent 20 and merges them into the mediating conditions in step S7. If there are user inquiring conditions in step S8, the user is inquired by a displaying process according to the HTML forming function of the user interface processing unit 16 in step S9, If the necessary conditions are obtained from the user in step S10, the obtained conditions are merged into the mediating conditions. Further, in step S11, if there are conditions which need a calculating process based on the user inquiring conditions, user obtaining conditions are substituted into the calculating expression and the necessary conditions are calculated in step S12. Subsequently, priorities of the contents are inquired of the user in step S13. In accordance with the user designation, a plurality of requesting conditions are finally formed from the decided mediating condition list data in step S14, and priorities have been allocated to the request contents in each of the requesting conditions.

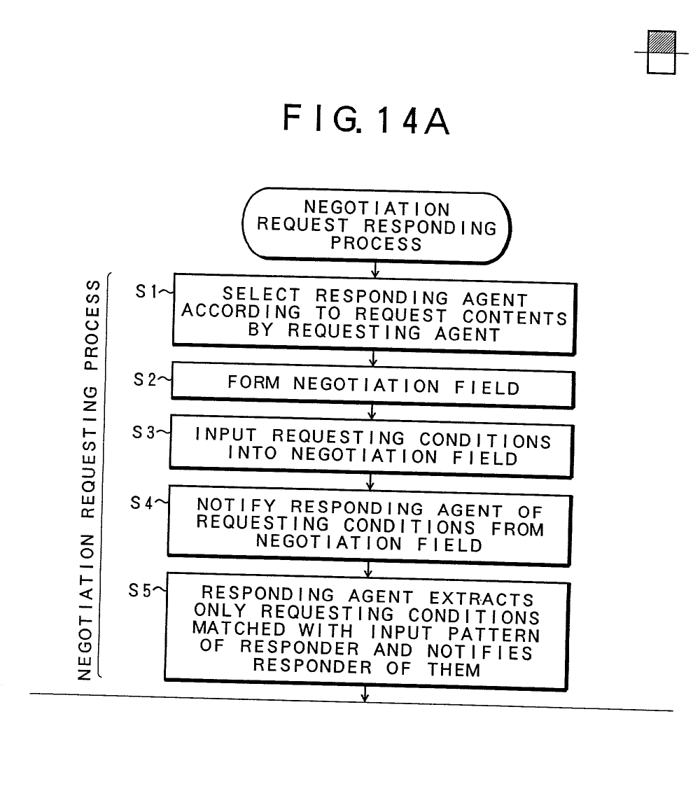

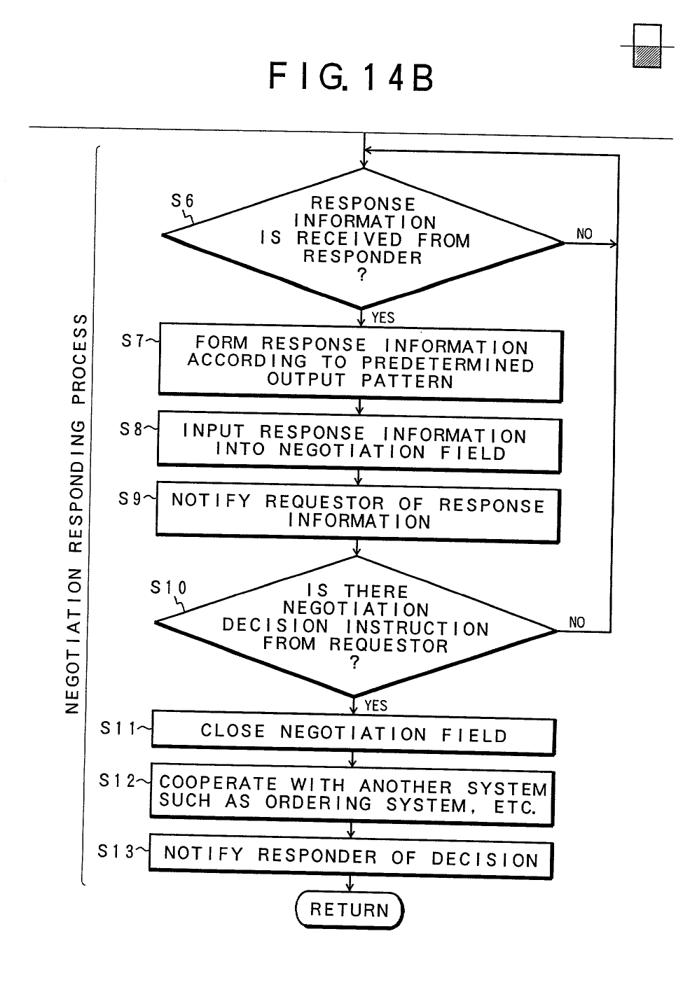

FIGS. 14A and 14B are flowcharts showing the detailed contents of a negotiation request responding process which is executed subsequently to the requesting condition forming process in FIGS. 13A and 13B. Steps S1 to S5 relate to the negotiation requesting process. Next steps S6 to S13 relate to the negotiation responding process. First, in negotiation requesting process, in step S1, the negotiation requesting agent 24 who received the requesting conditions formed by the mediation service processing unit 12 selects the negotiation responding agent in accordance with the request contents. In the embodiment of FIGS. 1A and 1B, although there is one negotiation responding agent 25, if a plurality of negotiation responding agents are provided in accordance with request contents, the negotiation responding agents corresponding to the request contents are selected. Subsequently, in step S2, a negotiation field as a site for a negotiation is formed. In step S3, a negotiation term is set into the formed negotiation field and the requesting conditions are inputted therein. In step S4, the responding agent 25 is notified of the requesting conditions from the negotiation field. In step S5, the responding agent 25 who received the notification of the requesting conditions reads out the input pattern from the input pattern file 26 every responder, extracts only the requesting conditions matched with the input pattern of each responder, clarifies the priorities of the request contents to the backend servers 38-1 to 38-n serving as responders, and notifies of the requesting conditions. Subsequently, the negotiation responding process is executed. In the negotiation responding process, when the responding agent 25 receives the response information from one of the backend servers 38-1 to 38-n in step S6, response information according to a preset output pattern in the output pattern file 28 is formed in step S7. The response information is inputted into the negotiation field in step S8. The response information inputted into the negotiation field is notified to the WWW browser 34 of the client 32 by the requesting agent 24 in step S9 and displayed to the requestor. In this instance, if there are a plurality of response information, the requesting agent 24 sorts the requesting conditions in accordance with the priorities and notifies of the sorted requesting conditions. At the same time, even on the backend servers 38-1 to 38-n side, the notification of the response information inputted into the negotiation field can be seen through the requesting agent 24. In step S10, subsequently, the presence or absence of a negotiation decision instruction from the requestor is discriminated. If there is the negotiation decision instruction, the negotiation field is closed in step S11 and a cooperating process with another system such as an ordering system or the like is performed in step S12. After that, a decision notification is performed to the backend server on the decision destination side serving as a responder in step S13. A series of negotiating processes is finished.

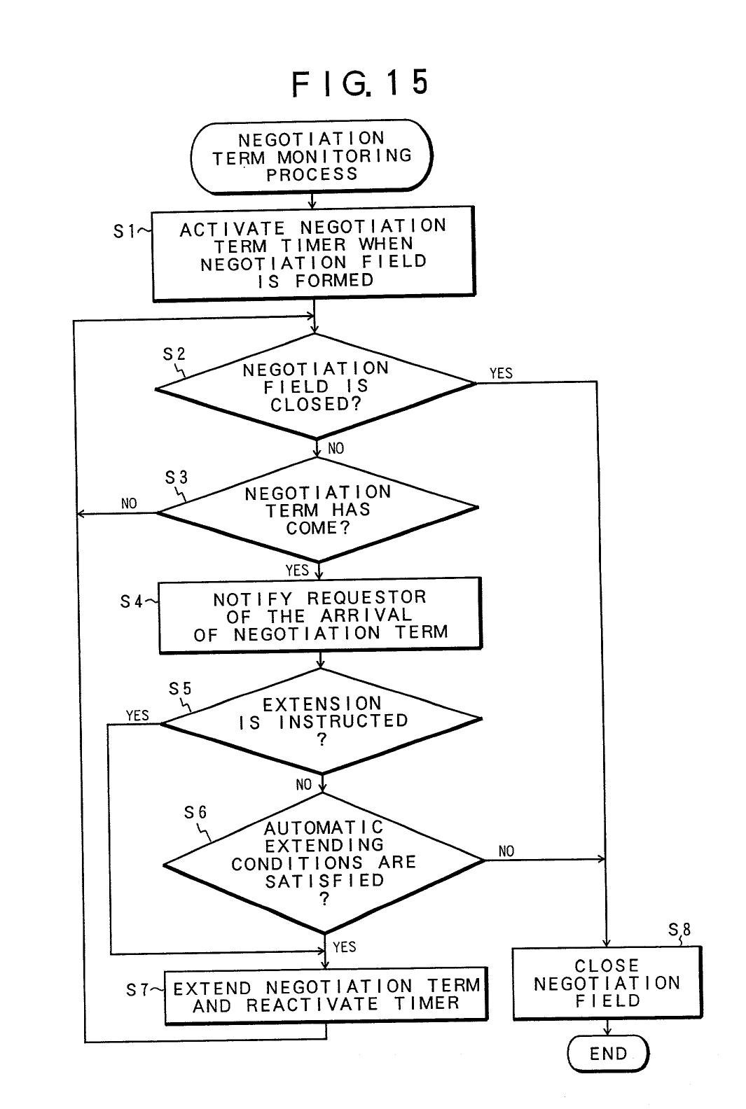

FIG. 15 is a flowchart for a negotiation term monitoring process for monitoring a negotiation term of the negotiation field formed in the invention. For example, the requesting agent 24 in FIGS. 1A and 1B or a dedicated negotiation term monitoring agent executes the process. In the negotiation term monitoring process, in step S1, a negotiation term timer in which a predetermined negotiating time has been set is activated upon formation of the negotiation field. Whether the negotiation field is closed or not is discriminated in step S2 during the negotiation. If there is the negotiation decision instruction from the requestor in step S10 as shown in the flowchart for the negotiation request responding process in FIGS. 14A and 14B, the negotiation field is closed in step S11. In this case, therefore, the negotiation term monitoring process is finished. If the negotiation field is not closed, whether the negotiation term has come or not is discriminated in step S3. If the negotiation term comes, the requestor is notified of the expiration of the negotiation term in step S4. After that, an extending instruction is waited in step S5. If there is the extending instruction, the negotiation term is extended and the timer is reactivated in step S7. The processing routine is returned to the process in step S2. If there is no extending instruction, whether predetermined automatic extending conditions are satisfied or not is discriminated in step S6. For example, the following conditions are set as automatic extending conditions.

(I) No valid response information is obtained (the number of responses is equal to 0).

(II) No satisfactory response is obtained (the contents of the responding conditions do not satisfy initial conditions of the requestor).

(III) The optimum information cannot be determined from a plurality of response information (in the case where a plurality of similar response information has been received, so that it is necessary to further narrow them down).

If at least one of the above three conditions is satisfied, the processing routine advances to step S7 from step S6. The negotiation term is extended and the timer is reactivated. The processing routine is returned to the process in step S2. If there is no extending instruction in step S5 and the automatic extending conditions are not satisfied in step S6, the negotiation field is closed on the basis of the expiration of the negotiation term in step S8. The series of mediation negotiating process is finished.

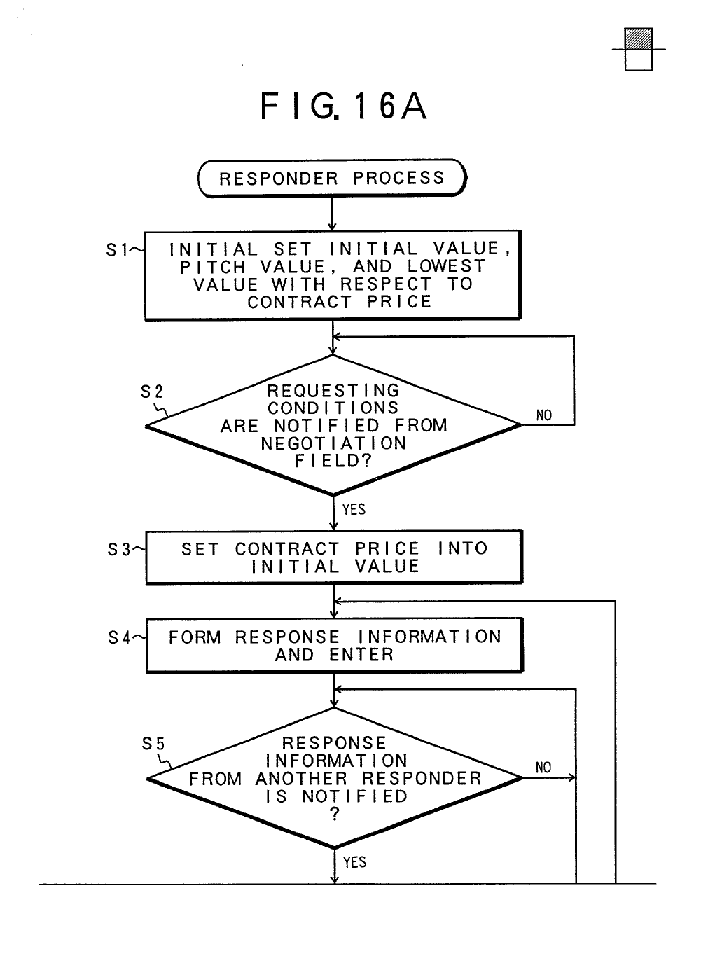

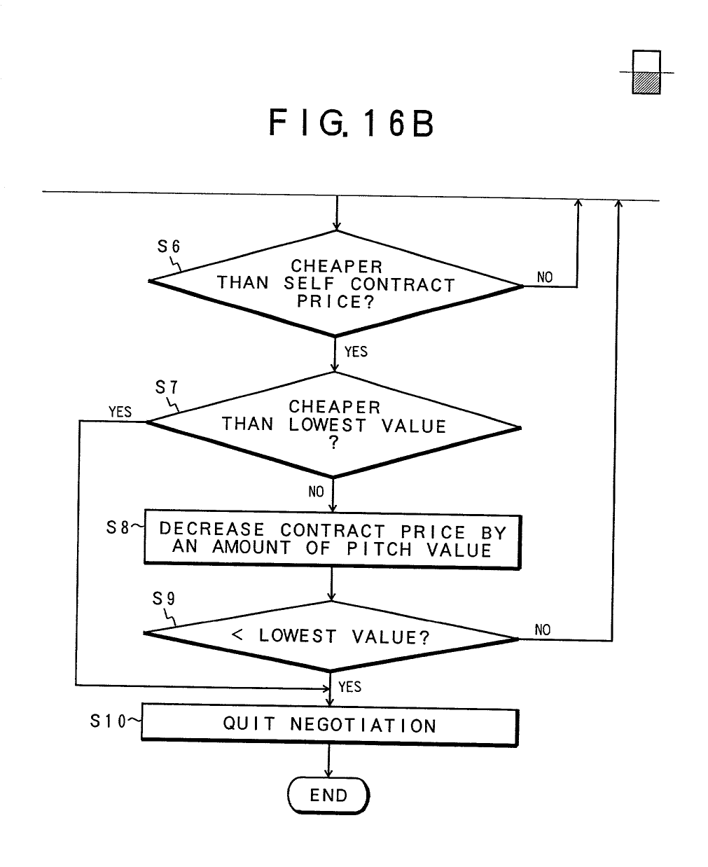

FIGS. 16A and 16B are flowcharts for responder processes which are executed in the backend servers 38-1 to 38-n serving as responder servers in the network system in FIGS. 1A and 1B, and it is characterized by executing a process for reducing his own bid price in response to the price presented from the competitor inputted into the negotiation field. First, in step S1, an initial value, a pitch value, and a lowest value are initially set with respect to the bid price. For example, with respect to the bid price of a PC, initially, the initial value is set to ¥200,000, the pitch value is set to ¥5,000, and the lowest value is set to ¥180,000. Subsequently, in step S2, the presence or absence of the notification of the requesting conditions from the negotiation field is discriminated. If there is a notification of the requesting conditions regarding the PC, the bid price is set to the initial value ¥200,000 in step S3. Response information is formed and inputted into the negotiation field in step S4. Subsequently, in step S5, the presence or absence of a notification of response information from another responder is discriminated. If there is the response information from another responder, whether the price presented from the competitor is cheaper than the self current bid price or not is discriminated in step S6. If the price presented from the competitor is cheaper than the self current bid price, whether the price presented from the competitor is lower than the lowest value or not is discriminated in step S7. If it is lower than the lowest value, step S10 follows and the responder breaks off the negotiation. If the price presented from the competitor is equal to or higher than the lowest value, the pitch value is subtracted from the bid price in step S8. Under a condition such that the presented price is not lower than the lowest value in step S9, the processing routine is returned to step S4 and the process for forming the response information and inputting it into the negotiation field is repeated. If the presented price is lower than the lowest value in step S9 as a result of the reduction of the bid price, the responder breaks off the negotiation in step S10. With respect to the bid price at the time when the competitor exists in the negotiation field, a method of inputting the response information in which the lowest value is first set in the case where the competitor is recognized can be also used without decreasing the price step by step as shown in FIGS. 16A and 16B. A proper corresponding process can be also performed in accordance with a situation in the negotiation field.

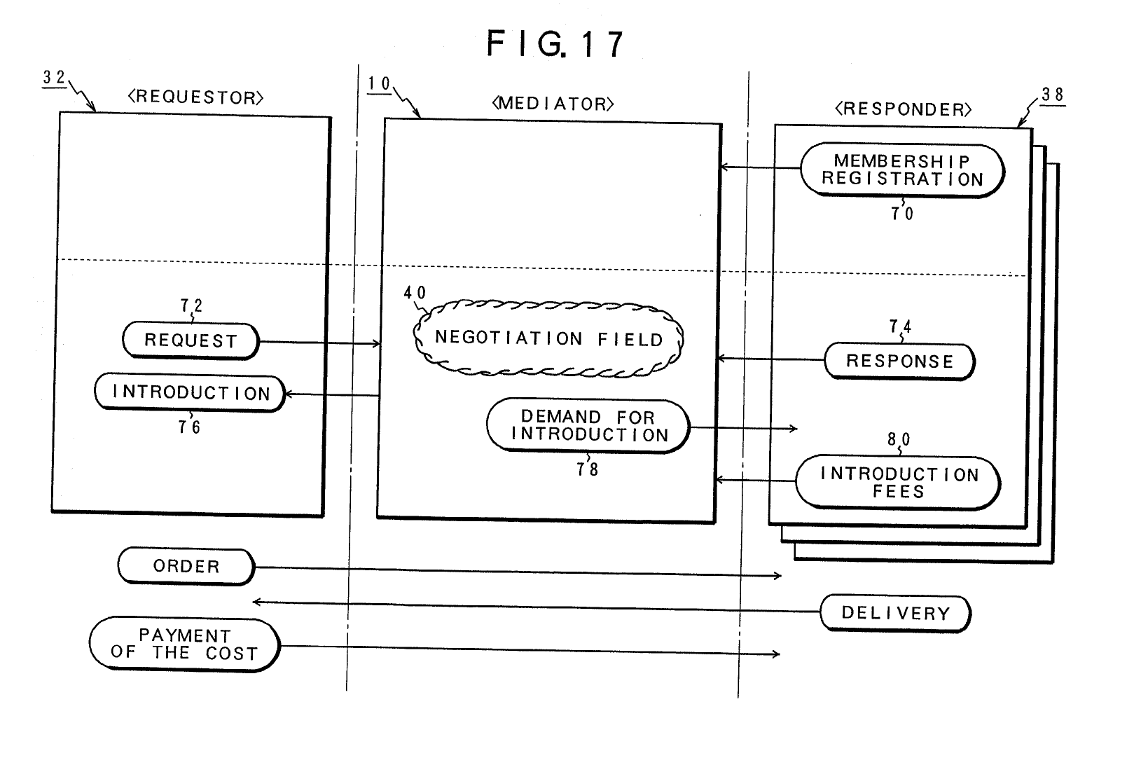

FIG. 17 is an explanatory diagram of a work introducing model of small and medium enterprises as an application example of the mediation negotiating method of the invention. The work introducing model of small and medium enterprises is away from the conventional series and becomes a model for selecting an optimum ordering destination from a group of small and medium enterprises. The mediator can operate the site for a negotiation with an income of an introduction fee. A backend server 38 as a responder constructed by small and medium enterprises first performs a membership registration 70 into the mediator server 10 as a mediator. When there is a request 72 from the client 32 as a requestor, the mediator server 10 forms the negotiation field 40, inputs requesting conditions according to the request 72 into the negotiation field 40, selects responders corresponding to the request contents from each of the small and medium enterprises on the backend server 38 side, and notifies the responders of the requesting conditions. If there is a response 74 from the backend servers 38-1 to 38-n side, the mediator server 10 notifies the client 32 of the response 74 as an introduction 76. If the mediation is concluded as mentioned above, a request of a demand for introduction 78 is made from the mediator server 10 to the backend server 38 side and an introduction fee 80 is paid in response to the demand 78. The subsequent ordering, delivery, and payment of the cost are executed as works different from those of the network system.

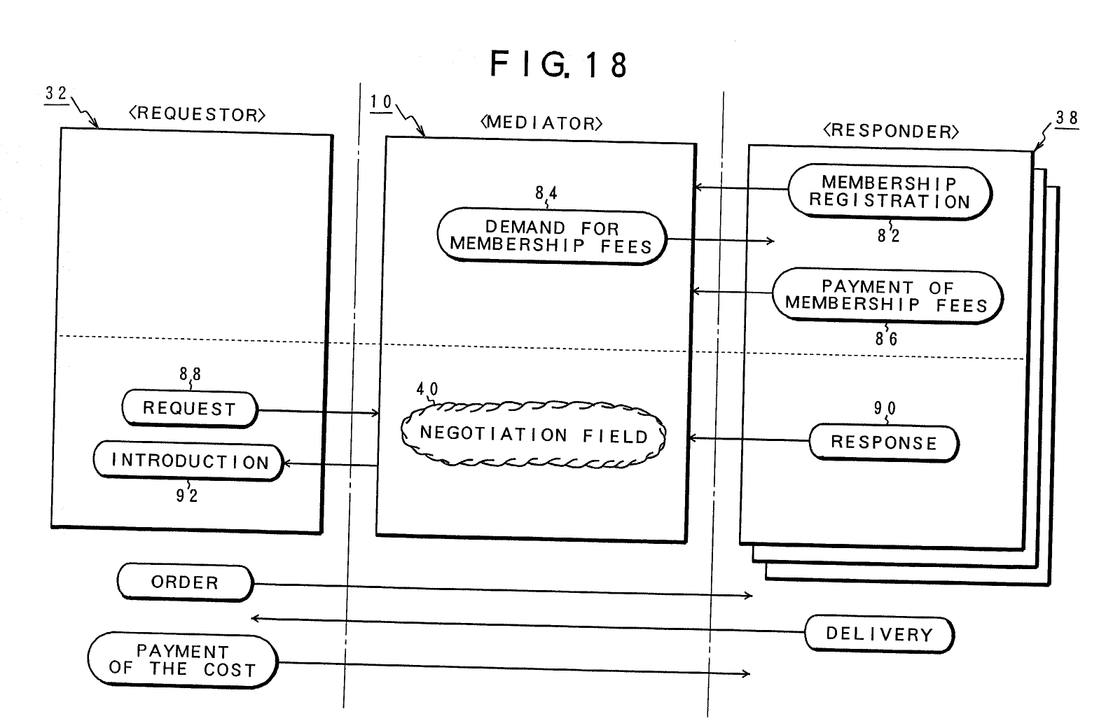

FIG. 18 is an explanatory diagram in which a professional association model such that a nonprofit organization such as business world organization, the Chamber of Commerce and Industry, or the like introduces the optimum works to the members for the benefit of the organization, that is, an increase in number of subscribers to the organization or the like is constructed by the mediation negotiating method of the invention. Also in this case, the mediator can operate the site for a negotiation by using the fees of the responders as members. A fundamental procedure is similar to that of the work introducing model of small and medium enterprises in FIG. 17, and a membership registration 82, a request 88, a response 90, and an introduction 92 are executed. However, since the organization is the nonprofit organization, the procedure differs from that of FIG. 17 with respect to a point that a demand for membership fees 84 is issued from the mediator server 10 to the backend server 38 as a responder and a response is made by a payment of membership fees 86.

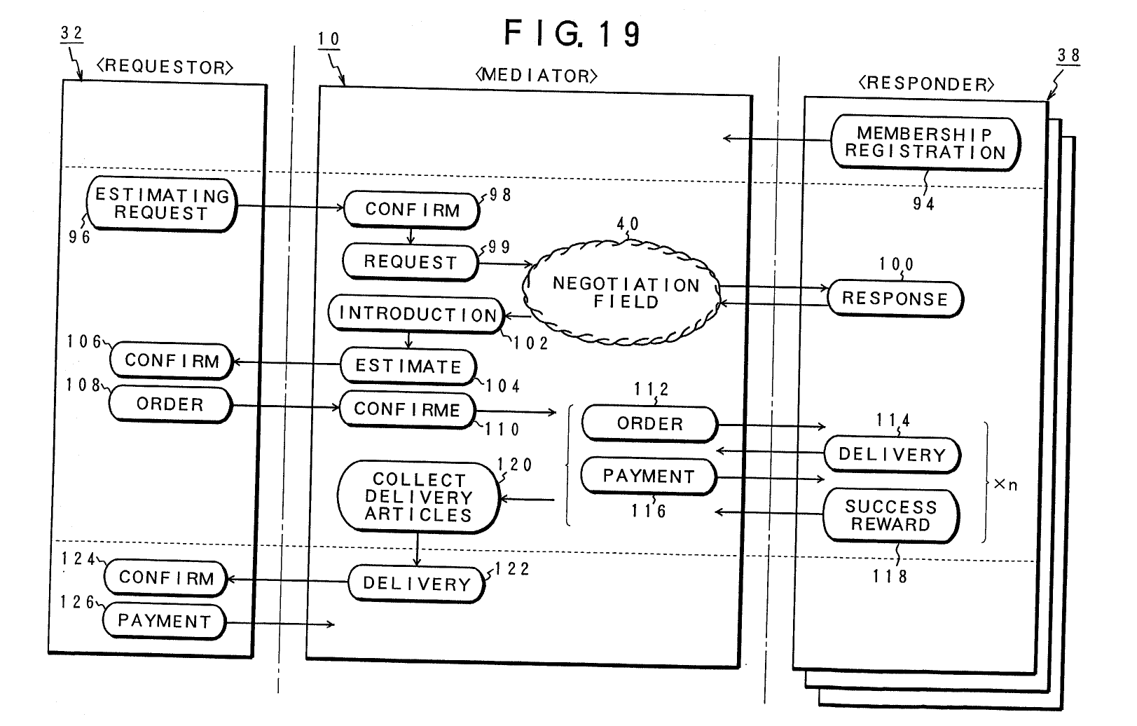

FIG. 19 is an explanatory diagram of a wholesaler model embodying the mediation negotiating method of the invention. This wholesaler model is a model in which the works which have been manually performed by a wholesaler hitherto are vicariously executed and optimized. First, a membership registration 94 is performed to the wholesaler possessing the mediator server 10 from the backend server 38 as a responder serving as a subcontract trader. If an estimating request 96 is received from the client 32 of the requestor in this state, the mediator server 10 makes a confirmation 98 and, thereafter, forms the negotiation field 40, issues a request 99, and returns an estimation 104 by an introduction 102 based on a response 100 from the responder. The requester receives the estimation 104, makes a confirmation 106, and issues an order 108. The mediator server 10 makes a confirmation 110 to the order 108 and issues an order 112 to the backend server 38 of the responder. In response to the order, the backend server 38 of the responder performs a delivery 114 and receives a payment 116 from the mediator server 10. In response to the payment 116, the backend server 38 of the responder pays a success reward 118. The order 112, delivery 114, payment 116, and success reward 118 are repeated n times. At this stage, the mediator server 10 performs a collection 120 of delivery articles and performs a delivery 122. When the client 32 of the requestor confirms (124) the delivery 122, he finally makes a payment 126. As mentioned above, the mediation negotiating method of the invention can be applied to proper works so long as it relates to a transaction form such that the three parties such as requester, mediator, and responder exist.

A computer-readable recording medium on which a program which is installed into the mediator server 10 and executed in order to realize the mediation negotiating method of the invention has been recorded will now be described. The program for realizing the mediation negotiating method of the invention comprises: a requesting condition forming program serving as a logic processing unit 15 provided for the mediation service processing unit 12 in FIGS. 1A and 1B; a program for the requesting agent 24; and further, a program for the responding agent 25. Specifically speaking, the requesting condition forming program for the logic processing unit 15 has processing steps shown in the flowcharts of FIGS. 13A and 13B. The program for the requesting agent 24 has processing steps S1 to S5 in FIG. 14A. Further, the program for the responding agent 25 has processing steps S6 to S13 shown in the flowcharts of FIGS. 14A and 14B. A program having processing steps for the negotiation term monitoring process in FIG. 15 is also provided as necessary. Further, with respect to the backend servers 38-1 to 38-n on the responder side, there is a program for the responder processes having the processing steps in FIGS. 16A and 16B. The responder processing program can be also provided as wrapping tools 36-1 to 36-n instead of the backend servers 38-1 to 38-n. The programs which are used in the mediation negotiating method of the invention as mentioned above are stored into a portable storage medium such as CD-ROM, floppy disk, DVD, magnetooptic disk, IC card, or the like, or installed from a database or another computer system by using a modem or an LAN interface. The programs of the invention installed as mentioned above are inputted into a computer system and executed, for example, as a mediator server 10. Naturally, the responder processing program is executed as backend servers 38-1 to 38-n. The program for the mediation negotiating method of the invention which is installed into a computer is stored into its hard disk (HDD) and executed by a CPU by using an RAM or the like.

According to the invention as mentioned above, the following effects are obtained with respect to each of the requestor, mediator, responder, and further, the system. First, as effects on the requester, merely by issuing an abstract mediating request, specific requesting conditions are formed and inputted into the site for a negotiation. Therefore, there is no troublesomeness upon inputting for mediation and the mediation can be easily requested. With respect to the requesting conditions, since priorities can be allocated to the request contents such as money amount, term of delivery, manufacturer, quality, and the like and they can be requested, a request corresponding to a sense of value of the requestor can be made, and a response corresponding to the request contents is obtained. Therefore, a best choice which the requester desires can be realized. It is also possible to shift to the direct negotiation of the requestor against the responder at the halfway while looking at the response to the requesting conditions. Further, a request in which a plurality of conditions are combined can be easily issued. As effects on the mediator, it is sufficient to set the condition items which are used for negotiations and the works such as classification into a category and the like are unnecessary in principle. At the initial stage, it is also possible not to set the condition items but to use the items whose negotiations with the responder have been decided in response to the request as standard items. In case of consignment for purchase or consignment for sale, consignment fee can be got. Further, a success reward, a registration fee, and an entry fee can be freely set. Compatibility or the like due to a past negotiation conclusion situation or the like can be applied there. Merely by providing the site for a negotiation, sufficient monetary benefit can be obtained. As effects on the responder, it is sufficient that the responder merely provides his own accepting conditions. There is no concept of a category. The responder can respond to all requests which are matched with the presented conditions and can obtain many business chances. Since the site for a negotiation is formed every requesting condition, the responder can simultaneously participate in a plurality of negotiation sites, so that he can select a business deal of the best conditions. If the requests are not matched with the requesting conditions, the responder can exit from the negotiation site any time. Although a person executes a responding work for the request, the response itself can be also automatized, so that consignment sale based on the automatization of the response can be also performed.

The invention is not always limited to a commodity transaction or service offer which is accompanied with money amount but can be also applied to a production schedule, inventory control, or the like which is not accompanied with a monetary transaction.

In the embodiment, as a method of forming the requesting conditions for the mediating request, the mediation service process for forming the specific requesting conditions in response to the abstract and uncertain mediating request with reference to the mediating condition list file or personal information file has been described as an example. However, the invention is not limited to such a method of forming the requesting conditions but can be also similarly applied to a case where the requestor fixedly determines the requesting conditions themselves and requests the mediation. That is, the invention also incorporates a case where the requestor directly forms, for example, the requesting conditions with priorities as shown in FIG. 7 by the client 32 in FIGS. 1A and 1B and requests to the mediator server.

In the above embodiment, although the negotiation field is closed upon decision of the negotiation, there is a case where a transaction is not concluded even at a stage where an individual negotiation is started after the decision of the negotiation and there is also a possibility that the requestor returns to the negotiation field again. Therefore, it is also possible to use a method whereby a confirmation (a term at which the negotiation can be interrupted is predetermined) for the requestor is obtained, the negotiation field is temporarily interrupted, the responder is notified of a fact that the field is in the interrupting state and there is a possibility of resumption, and when a restarting request from the requestor is received, the negotiation field is restarted. When the interruption term expires, the negotiation field is closed after completion of the confirmation to the requestor. The valid term has been set in the response information that is inputted into the negotiation field and the request whose valid term has been expired during the interruption is automatically deleted from the negotiation field.

The responder doesn't need to have the server. In this case, it is sufficient to change the information for the responder of the mediator server and use it.

The invention incorporates many proper variations and modifications without losing the objects and advantages of the invention. Further, the invention is not limited by the numerical values shown in the foregoing embodiment.

What is claimed is:

1. A mediation negotiating method of mediating a negotiation between a requestor and responders by using a network, comprising:
a request forming step which forms requesting conditions in which priorities have been allocated to request contents in response to a mediating request of said requestor;
a negotiation requesting step which forms a negotiation field, inputs said requesting conditions, and notifies the requesting conditions to the responders selected in accordance with said requesting conditions; and
a negotiation responding step which receives response information from the responders who participate in said negotiation field and notifies said requestor and the other responders of the received response information.

2. A method according to claim 1, wherein in said request forming step, priorities are allocated to request articles or the request contents such as service, price, term of delivery, and the like, thereby forming the requesting conditions with said priorities as said requesting conditions.

3. A method according to claim 1, wherein in said negotiation responding step, when said requestor is notified of the response information inputted into said negotiation field, the response information sorted in accordance with the priorities of said request contents is notified.

4. A method according to claim 1, wherein in said request forming step, an abstract mediating request from the requester is analyzed and one or a plurality of requesting conditions are formed.

5. A method according to claim 1, wherein in said negotiation requesting step, the request contents including the priorities in the requesting conditions inputted into said negotiation field are changed and inputted again.

6. A method according to claim 1, wherein in said negotiation requesting step, if there are a plurality of requesting conditions, the responder is selected under a condition that he corresponds to at least one of said plurality of requesting conditions, and the negotiation field between the responders and said requestor is formed.

7. A method according to claim 1, wherein
in said negotiation requesting step, a negotiation term is set into said negotiation field and the requesting conditions are inputted, and
in said negotiation responding step, the end of the negotiation is discriminated and the negotiation field is closed.

8. A method according to claim 7, wherein in said negotiation responding step, the negotiation field is closed by a negotiation decision instruction of said requestor or an expiration of the negotiation term.

9. A method according to claim 7, wherein in said negotiation responding step, the negotiation term is extended on the basis of an instruction from the requestor.

10. A method according to claim 7, wherein in said negotiation responding step, when conditions which have been preset are satisfied upon expiration of the negotiation term, the negotiation term is automatically extended.

11. A method according to claim 10, wherein when there is no response information or the number of response information does not reach a predetermined threshold value upon expiration of the negotiation term, the negotiation term is automatically extended.

12. A computer-readable recording medium in which a mediation negotiation program has been stored, wherein said mediation negotiation program comprises:
a request forming step which forms requesting conditions in which priorities have been allocated to request contents in response to a mediating request of a requester;
a negotiation requesting step which forms a negotiation field, inputs said requesting conditions, and notifies the responders selected in correspondence to said requesting conditions of said requesting conditions; and
a negotiation responding step which receives response information from the responders who participate in said negotiation field and notifies said requester and the other responders of said received response information.

13. A mediation negotiating program, which causes a computer of execute:
a request forming step which forms requesting conditions in which priorities have been allocated to request contents in response to a mediating request of a requestor;
a negotiation requesting step which forms a negotiation field, inputs said requesting conditions, and notifies the responders selected in correspondence to said requesting conditions of said requesting conditions; and
a negotiation responding step which receives response information from the responders who participate in said negotiation field and notifies said requester and the other responders of said received response information.

14. A negotiation responding method comprising:
a receiving step which receives request information inputted into a negotiation field formed on a network; and
a negotiation responding step which prepares an initial value, a pitch value, and a lowest value with respect to a bid price, first inputs response information in which the initial value has been set to said bid price, in the case where another response information of a cheap bid price is recognized in said negotiation field, again inputs response information in which the bid price has sequentially been corrected on a unit basis of said pitch value, and in the case where a bid price of a competitor is lower than said lowest value, stops the input of the response information and breaks off the negotiation.

15. A computer-readable recording medium in which a responder program has been stored, wherein said responder program comprises:
a receiving step which receives request information inputted into the negotiation field formed on a network; and
a negotiation responding step which prepares an initial value, a pitch value, and a lowest value with respect to a bid price, first inputs response information in which the initial value has been set to the bid price, in the case where another response information of a cheap bid price is recognized in said negotiation field, again inputs response information in which the bid price has sequentially been corrected on a unit basis of said pitch value, and in the case where a bid price of a competitor is lower than said lowest value, stops the input of the response information and breaks off the negotiation.

16. A responder program, which causes a computer to execute:
a receiving step which receives request information inputted into the negotiation field formed on a network; and
a negotiation responding step which prepares an initial value, a pitch value, and a lowest value with respect to a bid price, first inputs response information in which the initial value has been set to the bid price, in the case where another response information of a cheap bid price is recognized in said negotiation field, again inputs response information in which the bid price has sequentially been corrected on a unit basis of said pitch value, and in the case where a bid price of a competitor is lower than said lowest value, stops the input of the response information and breaks off the negotiation.
